(19) United States
(12) Patent Application Publication
(10) Pub. No.: US 2018/0330363 A1
(43) Pub. Date: Nov. 15, 2018

(54) METHOD FOR PROVIDING USER INTERFACE RELATED TO CARD, AND ELECTRONIC DEVICE FOR IMPLEMENTING SAME

(71) Applicant: Samsung Electronics Co., Ltd., Gyeonggi-do (KR)

(72) Inventor: Jooyoun PAEK, Seoul (KR)

(21) Appl. No.: 15/776,975

(22) PCT Filed: Nov. 15, 2016
(86) PCT No.: PCT/KR2016/013124

§ 371 Date: May 17, 2018

(30) Foreign Application Priority Data
Nov. 18, 2015 (KR) 10-2015-0161956

(51) Int. Cl. G06Q 20/34; G06Q 20/10

(52) U.S. Cl. CPC G06Q 20/342; G06Q 20/322; G06Q 20/105

(57) ABSTRACT

Various examples provide a method and a device, the device comprising: a display for displaying a user interface; a memory; and a processor functionally connected to the display and the memory, wherein the processor controls the display such that the display displays a user interface related to at least one of a card registration, a card purchase, a card removal, or a payment method change. In addition, other examples are possible.

### TECHNICAL FIELD

Various embodiments are related to a method for providing a user interface related to a card, and an electronic device for implementing the same.

### BACKGROUND ART

With development of mobile communication technology, an electronic device may perform various data communication functions, as well as a voice call function. The electronic device, for example, a mobile device or a user equipment may provide various services through various applications. The electronic device may provide multimedia services, for example, a music service, a video service, or a digital broadcast service, or network-based communication services such as calls, wireless Internet, short message services (SMS), and multimedia messaging service (MMS).

In addition, the electronic device evolves from a simple communication medium to a device enabling various functions such as communication, distribution, Internet, or payment, and may be used across a social, cultural, financial, or retail industry. The electronic device, for example, may provide mobile payment via an electronic device in the payment function. The electronic device, for example, may make payment using the electronic device in the payment which has been made from cash to a credit card. The electronic device may, for example, using a mobile payment service, provide the payment function using the electronic device for services or goods purchased online or offline (if a product is purchased and the payment is processed in an actual shop or restaurant). Also, the electronic device may include, for example, a communication function for receiving or transmitting payment information.

### DISCLOSURE OF INVENTION

### Technical Problem

Various embodiments may improve user's convenience by providing a user interface which may process all of registration, purchase, and use management of a card.

### Solution to Problem

An electronic device according to various embodiments may include a display for displaying a user interface, a memory, and a processor functionally coupled with the display and the memory, wherein the processor may control to display a user interface relating to at least one of card registration, card purchase, card removal, or payment method change, on the display.

An operating method of an electronic device according to various embodiments may include displaying a user interface relating to at least one of card registration, card purchase, card removal, or payment method change, detecting a user event, and conducting a process relating to the card registration, the card purchase, the card removal, or the payment method change based on the detected user input.

### Advantageous Effects of Invention

According to various embodiments, an electronic device may improve user's convenience by providing a user interface which may process all of registration, purchase, and use management of a card.

According to various embodiments, in card registration, if a user inputs merely main information about a card, an electronic device may easily register the card by receiving additional information of the card from a server and configuring card information.

According to various embodiments, not only every card presented to a user may be registered but also only a desired card may be selectively registered and used.

According to various embodiments, if a user returns a card randomly presented, without registering it as his/her card, a server may re-present the returned card to other user.

According to various embodiments, card information may be manually entered by releasing card information required for payment if payment repeatedly fails.

According to various embodiments, a user interface for card purchase, payment, and use may be personalized and displayed based on user's use history.

### BRIEF DESCRIPTION OF DRAWINGS

FIG. 1 is a diagram illustrating a configuration of an electronic device according to various embodiments.

FIG. 2 is a flowchart illustrating a card registration method of an electronic device according to various embodiments.

FIGS. 3A through 3C are diagrams illustrating an example of a user interface relating to card registration according to various embodiments.

FIG. 4 is a flowchart illustrating a card information input method of an electronic device according to various embodiments.

FIGS. 5A and 5B are diagrams illustrating an example of a user interface relating to card information input according to various embodiments.

FIG. 6 is a flowchart illustrating a card purchase method of an electronic device according to various embodiments.

FIGS. 7A through 7C are diagrams illustrating an example of a user interface relating to card purchase according to various embodiments.

FIGS. 8A and 8B are diagrams illustrating an example of a user interface relating to payment in card purchase according to various embodiments.

FIG. 9 is a flowchart illustrating a card removing method of an electronic device according to various embodiments.

FIGS. 10A and 10B are diagrams illustrating an example of a user interface relating to card removal according to various embodiments.

FIG. 11 is a flowchart illustrating a payment method changing method of an electronic device according to various embodiments.

FIGS. 12A and 12B are diagrams illustrating an example of a user interface relating to payment method change according to various embodiments.

FIG. 13 is a diagram illustrating an example of a user interface in payment according to various embodiments.

### BEST MODE FOR CARRYING OUT THE INVENTION

Hereinafter, various embodiments of the present invention are described with reference to the accompanying drawings. However, it should be understood that there is no limiting of the present invention to particular forms disclosed herein, and the present invention should be understood to cover various modifications, equivalents, and/or alternatives of embodiments of the present invention. In describing the drawings, similar reference numerals may be used for similar constituent elements. Embodiments disclosed in the present invention are provided merely to easily describe and understand technical details, and are not intended to limit the scope of the present invention. Accordingly, the scope of the present invention should be construed as including all modifications or various other embodiments based on the technical idea of the present invention.

In embodiments of the present invention, an electronic device may include any device using one or more of various processors such as an application processor (AP), a communication processor (CP), a graphics processing unit (GPU), and a central processing unit (CPU), such as any information communication device, multimedia device, wearable device, and their application devices, supporting a function (e.g., a function for displaying a user interface regarding at least one of card registration, card purchase, card removal, or payment method change) according to various embodiments of the present invention.

An electronic device according to an embodiment of the present invention may include at least one of, for example, a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), a moving picture experts group audio layer 3 (MP3) player, a mobile medical appliance, a camera, or a wearable device (e.g., smart glasses, a head-mounted-device (HMD), or a smart watch).

Also, an electronic device in an embodiment of the present invention may be a smart home appliance. The smart home appliance may include at least one of, for example, a television, a digital video disk (DVD) player, a refrigerator, an air conditioner, a vacuum cleaner, a washing machine, a set-top box, a home automation control panel, a television (TV) box (e.g., Samsung HomeSync™, Apple TV™, or Google TV™), a game console (e.g., Xbox™, PlayStation™), or an electronic frame. Also, the electronic device may include at least one of a navigation device or an Internet of things (IoT) device.

In various embodiments, an electronic device may be a combination of one or more of those various devices. In an embodiment, the electronic device may be a flexible device. Also, the electronic device according to an embodiment of the present invention is not limited to the foregoing devices and may include a new electronic device based on technological development.

Also, the term user in an embodiment of the present invention may refer to a person using an electronic device or a device using an electronic device (e.g., an artificial intelligence electronic device). In an embodiment of the present invention, a module or a program module may further include at least one of the various components of the present invention, or omit some of them, or further include additional other components. Operations performed by modules, program modules, or other components according to various embodiments may be executed in a sequential, parallel, repetitive, or heuristic manner. In addition, some operations may be executed in a different order or be omitted, or other operations may be added.

Hereafter, a method and an apparatus for displaying content according to an embodiment of the present invention are explained by referring to the attached drawings.

However, various embodiments of the present invention are not restricted by or limited to contents which will be described below and therefore, and it should be noted that they may be applied to various embodiments based on the embodiments to be described below. In embodiments of the present invention described below, a hardware approach will be described as an example. However, since the embodiments of the present invention include a technology using both hardware and software, various embodiments of the present invention do not exclude a software-based approach.

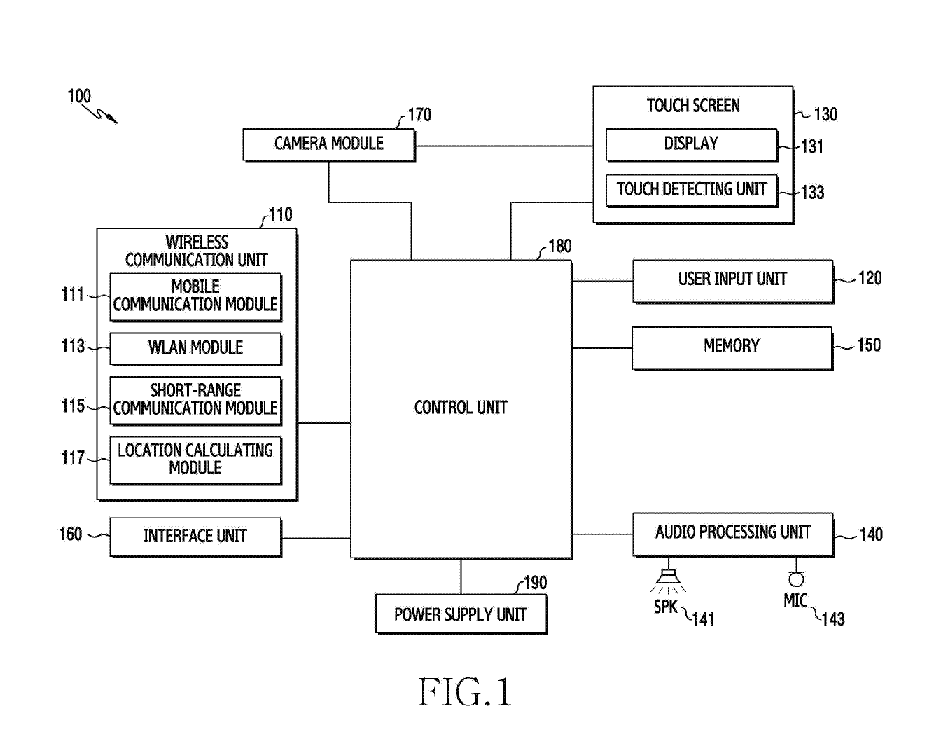

FIG. 1 is a diagram illustrating a configuration of an electronic device according to various embodiments.

Referring to FIG. 1, an electronic device 100 according to various embodiments of the present invention may include a wireless communication unit 110, a user input unit 120, a touch screen 130, an audio processing unit 140, a memory 150, an interface unit 160, a camera module 170, a control unit 180 (or processor), and a power supply unit 190. Besides, the electronic device 100 may further include an MST module, a payment module, a sensor module, or a fingerprint recognizing module. The electronic device 100 may not necessarily include the components of FIG. 1 in various embodiments of the present invention, and may be configured to include more or less components than the components of FIG. 1.

The wireless communication unit 110 may include one or more modules enabling wireless communications between the electronic device and other external electronic device. In various embodiments, the wireless communication unit 110 may include a module (e.g., a short-range communication module, a telecommunications module, etc.) for communicating with an external electronic device in vicinity. For example, the wireless communication unit 110 may include a mobile communication module 111, a wireless local area network (WLAN) module 113, a short-range communication module 115, a location calculating module 117, and so on.

The mobile communication module 111 may transmit and receive radio signals to and from a base station, an external electronic device, and at least one of various servers (e.g., an integration server, a provider server, a content server, an Internet server, or a cloud server) on a mobile communication network. The radio signals may include a voice signal, a data signal, or various control signals. The mobile communication module 111 may transmit various data required for operations of the electronic device 100, to an external device (e.g., a server or other electronic device) in response to a user request. In various embodiments, the mobile communication module 111 may transmit and receive radio signals based on various communication methods. For example, the communication methods may include, but not limited to, long term evolution (LTE), LTE advanced (LTE-A), global system for mobile communication (GSM), enhanced data GSM environment (EDGE), code division multiple access (CDMA), wideband CDMA (WCDMA), universal mobile telecommunications system (UMTS), or orthogonal frequency division multiple access (OFDMA).

The WLAN module 113 may indicate a module for establishing wireless Internet access and WLAN link with the other external electronic device. The WLAN module 113 may be embedded in or mounted outside the electronic device 100. The wireless Internet technique may employ wireless fidelity (WiFi), wireless broadband (Wibro), world interoperability for microwave access (WiMax), high speed downlink packet access (HSDPA), or millimeter wave (mmWave). In association with the other external electronic device connected with the electronic device 100 over the network (e.g., wireless Internet network), the WLAN module 113 may transmit or receive various data of the electronic device 100 to or from the outside (e.g., the external electronic device or the server). The WLAN module 113 may keep turning on, or be turned on according to setting of the electronic device 100 or a user input.

The short-range communication module 115 may indicate a module for performing short-range communication. The short-range communication may use Bluetooth, Bluetooth low energy (BLE), radio frequency identification (RFID), infrared data association (IrDA), ultra wideband (UWB), Zigbee, near field communication (NFC), magnetic stripe transmission (MST), or global navigation satellite system (GNSS). In association with the other external electronic device (e.g., an external sound device) connected with the electronic device 100 over the network (e.g., a short-range communication network), the short-range communication module 115 may transmit or receive various data of the electronic device 100 to or from the outside. The short-range communication module 115 may keep turning on, or be turned on according to the setting of the electronic device 100 or a user input.

The MST module may generate a pulse according to data transmitted using an electromagnetic signal. The pulse may generate a magnetic signal. The electronic device 100 may transmit the magnetic signal to a payment terminal (a point of sales (POS)), and the payment terminal may detect the magnetic signal using an MST reader and restore the data by converting the detected magnetic signal to an electrical signal.

The location calculating module 117 is a module for acquiring a location of the electronic device 100, and may include, for example, a global position system (GPS) module. The location calculating module 117 may measure the location of the electronic device 100 using triangulation. For example, the location calculating module 117 may calculate distance information and time information from three or more base stations, apply the triangulation to the calculated information, and thus calculate current three-dimensional location information based on latitude, longitude, and altitude. Alternatively, the location calculating module 117 may calculate the location information by continuously receiving location information of the electronic device 100 from three or more satellites in real time. The location information of the electronic device 100 may be acquired in various manners.

The user input unit 120 may generate input data for controlling the operation of the electronic device 100, in response to a user input. The user input unit 120 may include at least one input means for detecting user's various inputs. For example, the user input unit 120 may include a key pad, a dome switch, a physical button, a touch pad (resistive/capacitive), a jog & shuttle, and a sensor. Part of the user input unit 120 may be implemented as a button outside the electronic device 100, and part or whole may be implemented as a touch panel. The user input unit 120 may receive a user input for initiating the operation (e.g., a function for displaying a user interface regarding at least one of card registration, card purchase, card removal, or payment method change) of the electronic device 100, and generate an input signal according to the user input according to various embodiments of the present invention.

The touch screen 130 indicates an input/output device which may execute an input function and a displaying function at the same time, and may include a display 131 and a touch detecting unit 133. The touch screen 130 may provide an input/output interface between the electronic device 100 and the user, forward a user's touch input to the electronic device 100, and include an intermediary role for showing an output from the electronic device 100 to the user. The touch screen 130 may display a visual output to the user. The visual output may include text, graphics, video, and their combination. In an embodiment of the present invention, the touch screen 130 may display various screens according to the operation of the electronic device 100 through the display 131. As displaying a particular screen on the display 131, the touch screen 130 may detect an event (e.g., a touch event, a proximity event, a hovering event, an air gesture event) based on at least one of touch, hovering, and air gesture from the user through the touch detecting unit 133, and send an input signal based on the event to the control unit 180.

According to various embodiments of the present invention, the display 131 may display (output) various information processed in the electronic device 100. For example, the display 131 may display a user interface or a graphical UI (GUI) relating to card registration, card purchase, card return, card removal, or payment method change.

The display 131 may support a screen display in a landscape mode, a screen display in a portrait mode, or a screen display according to transition between the landscape mode and the portrait mode, based on a rotation direction (or an orientation) of the electronic device 100. The display 131 may employ various displays. In various embodiments, the display 131 may employ a bended display. For example, the display 131 may include a bended display which may be bent or rolled without damages by use of a thin and flexible substrate like paper.

The bended display may be coupled to a housing (e.g., a main body) and maintain its bent shape. In various embodiments, the electronic device 100 may be realized using a display device which may be freely bent and unrolled like a flexible display as well as the bended display. In various embodiments, the display 131 may give foldable and unfoldable flexibility by substituting a glass substrate covering a liquid crystal with a plastic film in a liquid crystal display (LCD), a light emitting diode (LED) display, an organic LED (OLED) display, an active matrix OLED (AMOLED) display, or an electronic paper. In various embodiments, the display 131 may be extended and coupled to at least one side (e.g., at least one of a left side, a right side, an upper side, and a lower side) of the electronic device 100.

The touch detecting unit 133 may be received in the display 131, and detect a user input for contacting or approaching a surface of the touch screen 130. The touch detecting unit 133 may receive the user input for initiating the operation to use the electronic device 100 and generate an input signal according to the user input. The user input may include a touch event or a proximity event input based on at least one of single-touch, multi-touch, hovering, or air gesture input. For example, the user input may be input using tap, drag, sweep, swipe, flick, drag and drop, or a drawing gesture (e.g., writing).

The audio processing unit 140 may send an audio signal input from the control unit 180, to a speaker (SPK) 141, and forward an audio signal such as a voice input from a microphone (MIC) 143 to the control unit 180. The audio processing unit 140 may convert and output voice/sound data as an audible sound through the speaker 141 under control of the control unit 180, and convert an audio signal such as a voice received from the microphone 143 into a digital signal and forward to the control unit 180. The audio processing unit 140 may output an audio signal responding to the user input according to audio processing information (e.g., an effect sound, a music file, etc.) inserted into data.

The speaker 141 may output audio data received from the wireless communication interface 110 or stored in the memory 150. The speaker 141 may output sound signals relating to various operations (functions) in the electronic device 100. Although not depicted in the embodiment of the present invention, the speaker 141 may connect an attachable and detachable earphone, a headphone, or a headset, to the electronic device 100 through an external port.

The microphone 143 may receive and process an external sound signal into electric voice data. Various noise reduction algorithms may be realized in the microphone 143 in order to eliminate noises generated when the received external sound signal is input. The microphone 143 may receive an audio stream such as a voice command (e.g., a voice command for initiating a music application). The microphone 143 may include an internal microphone built in the electronic device 100 and an external microphone connected to the electronic device.

The memory 150 may store one or more programs executed by the control unit 180, and may temporarily store input/output data. The input/output data may include, for example, video, image, photo, and audio files. The memory 150 may store the obtained data, the data obtained in real time may be stored in a temporary storage device, and data to store may be stored in a storage device allowing for long-term storage.

The memory 150 may store instructions executed to display a user interface relating to card registration, card purchase, card return, card removal, or payment method change, on the display. In various embodiments, the memory 150 may store instructions for, when executed, causing the control unit 180 (e.g., one or more processors) to display the user interface relating to at least one of the card registration, the card purchase, the card removal, or the payment method change, to detect a user input, and to perform a process of the card registration, the card purchase, the card removal, or the payment method change based on the detected user input.

The memory 150 may permanently or temporarily store an operating system (OS) of the electronic device 100, a program relating to the input and the display control using the touch screen 130, a program for controlling various operations (functions) of the electronic device 100, and various data occurred by the program operations.

The memory 150 may include an extended memory (e.g., an external memory) or an internal memory. The memory 150 may include at least one storage medium of memories of a flash memory type, a hard disk type, a micro type, and a card type (e.g., a secure digital (SD) card or an eXtreme digital (XD) card), and memories of a dynamic random access memory (DRAM), a static random access memory (SRAM), a read-only memory (ROM), a programmable ROM (PROM), an electrically erasable PROM (EEPROM), a magnetic RAM (MRAM), a magnetic disc, and an optical disc type. The electronic device 100 may operate in association with a web storage which serves as a storage function of the memory 150 on the Internet.

The memory 150 may store various software. For example, software components may include an OS software module, a communication software module, a graphic software module, a user interface software module, a MPEG module, a camera software module, and one or more application software modules. Also, the module which is the software component may be represented as a set of instructions and accordingly may be referred to as an instruction set. The module may be referred to as a program.

The OS software module may include various software components for controlling general system operations. Such general system operation control may indicate, for example, memory management and control, and power control and management. The OS software module may also facilitate communications between various hardware (devices) and software components (modules). The communication software module may enable communication with another electronic device, such as a computer, a server, or a portable terminal, through the wireless communication interface 110. Also, the communication software module may be configured in a protocol structure corresponding to a corresponding communication method.

The graphic software module may include various software components for providing and displaying graphics on the touch screen 130. The term graphics may encompass a text, a webpage, an icon, a digital image, a video, and an animation. The user interface software module may include various software components relating to the user interface (UI). For example, it is involved in a status change of the user interface and a condition for the user interface status change.

The MPEG module may include a software component enabling digital content (e.g., video, audio) processes and functions (e.g., content creation, reproduction, distribution, and transmission). The camera software module may include camera related software components allowing camera related processes and functions.

The application module may include a web browser including a rendering engine, email, instant message, word processing, keyboard emulation, address book, widget, digital right management (DRM), iris scan, fingerprint scan, context cognition, voice recognition, and a location based service. According to various embodiments of the present invention, as outputting a sound sample corresponding to a selected cell, the application module may process operations (functions) for displaying a representative color of the selected cell and displaying a trace effect in an area between two cells.

The interface unit 160 may receive data or power from other external electronic device and provide to the components of the electronic device 100. The interface unit 160 may transmit data from the electronic device 100 to the other external electronic device. For example, the interface 160 may include a wired/wireless headphone port, an external charger port, a wired/wireless data port, a memory card port, an audio input/output port, a video input/output port, and an earphone port.

The camera module 170 indicates a configuration for supporting a camera function of the electronic device 100. The camera module 170 may capture an object under control of the control unit 180 and send the captured data (e.g., an image) to the display 131 and the control unit 180. The camera module 170 may include one or more image sensors. For example, the camera module 170 may include a front-facing sensor (e.g., a front-facing camera) disposed on a front side (e.g., the same plane as the display 131) of the electronic device 100, and a rear-facing sensor (e.g., a rear-facing camera) disposed on a back side (e.g., a rear side) o the electronic device 100.

The control unit 180 may control general operations of the electronic device 100. For example, the control unit 180 may perform various controls on music play, metronome function processing, visualization of musical attributes, voice communication, data communication, and video communication. The control unit 180 may be implemented using one or more processors, or the control unit 180 may be referred to as a processor. For example, the control unit 180 may include a CP, an AP, an interface (e.g., general purpose input/output (GPIO)), or an internal memory, as separate components, or may integrate them on one or more integrated circuits. The AP may conduct various functions for the electronic device 100 by executing various software programs, and the CP may process and control voice communications and data communications. Also, the control unit 180 may execute a particular software module (an instruction set) stored in the memory 150 and thus carry out specific functions corresponding to the module.

In various embodiments of the present invention, the control unit 180 may process operations for displaying the user interface regarding at least one of the card registration, the card purchase, the card removal, or the payment method change, on the display 131, detecting the user input, and conducting the process of the card registration, the card purchase, the card removal, or the payment method change, based on the detected user input. The control operation of the control unit 180 according to various embodiments of the present invention is now described with the drawings.

The control unit 180 according to an embodiment of the present invention may control various operations relating to typical functions of the electronic device 100 in addition to the above-stated functions. For example, the control unit 180 can, when a particular application is executed, control its operation and the screen display. Also, the control unit 180 may receive an input signal corresponding to various touch event or proximity event inputs supported by a touch-based or proximity-based input interface (e.g., the touch screen 130), and control its function operation. Also, the control unit 180 may control various data transmissions and receptions based on the wired communication or the wireless communication.

The power supply unit 190 may receive external power or internal power and supply the power required to operate the components under control of the control unit 180. In an embodiment of the present invention, the power supply unit 190 may supply or cut (on/off) the power to display 131 and the camera module 170 under the control of the control unit 180.

The fingerprint scan module may be a module for recognizing a fingerprint. For example, security verification may be conducted using the fingering in order to use a payment application payment service. The electronic device 100 may or may not already set the fingerprint to disable the security in the basic operation of the electronic device 100. At this time, if the fingerprint is registered for the security of the electronic device 100, this process is omitted and the registered fingerprint may be used for the payment. In an additional embodiment, the fingerprint registration process may be omitted regardless of whether the fingerprint is registered in the electronic device 100.

The fingerprint scan may support both of an area type and a swipe type, and may mix the two types. That is, even when the area type is registered, both of the area type and the swipe type may be used in the actual payment. It is noted that the sensor module or the fingerprint scan module support the two types.

Various embodiments described in the present invention may be implemented in a recording medium which may be read by a computer or a similar device using software, hardware, or a combination thereof. According to hardware implementation, embodiments described in the present invention may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units for performing other functions.

In an embodiment of the present invention, the recording medium may include a computer-readable recording medium which records a program for displaying the user interface regarding at least one of the card registration, the card purchase, the card removal, or the payment method change, detecting the user input, and conducting the process of the card registration, the card purchase, the card removal, or the payment method change, based on the detected user input.

In some cases, various embodiments described in the present invention may be implemented by the control unit 180. Also, according to software implementation, embodiments such as the procedures and the functions explained in the present disclosure may be implemented by separate software modules. The software modules each may execute one or more functions and operations described in the disclosure.

A card described hereafter explains a gift card by way of example. The gift card may be a concept encompassing not only a gift card currently so called but also other cards named differently which are available in a similar or identical manner to the gift card.

An electronic device according to various embodiments may include a display for displaying a user interface, a memory, and a processor functionally coupled with the display and the memory, wherein the processor may control to display a user interface relating to at least one of card registration, card purchase, card removal, or payment method change, on the display.

The processor may be configured to, if detecting a card add event, display a user interface for additional card registration, and to register card information by conducting an information input process or a card purchase process based on a user input.

The information input process may provide a user interface for entering at least one of a card brand, a card number, or a PIN number from a user, and provide a user interface including card information generated using the entered information and additional information received from a server.

The processor may be configured to transmit the entered information to the server, to receive additional information corresponding to the entered information from the server, to generate the card information based on the entered information and the additional information, and to register the generated card information.

The card purchase process may provide a user interface for entering card configuration information from a user, and provide an information input interface for presenting a card or an information input interface for purchasing a card.

If payment is completed by conducting a payment process according to a card purchase, the processor may be configured to register card information of a purchased card in a card-related application, or to transmit the card information of the purchased card to an electronic device of other party to send a gift.

The processor may be configured to display a user interface including a presented card, to identify a type of a card selected from a user, and to display a different user interface according to an identified type.

If the identified type is a first type, the processor may be configured to display a user interface regarding a first-type card, if return is selected in the user interface regarding the first-type card, to transmit card information of a returned card to a server, and to remove the returned card information from a user interface including the presented card.

If the identified type is a second type, the processor may be configured to display a user interface regarding a second-type card, and if removal is selected in the user interface regarding the second-type card, not to register card information of a removed card in a card-related application.

If a payment request event is detected, the processor may be configured to display a user interface for payment, to process payment in a preset payment method, and to process payment by changing a payment method if the payment fails.

If a number of payment failures exceed a preset count, the processor may be configured to display a payment number relating to card information.

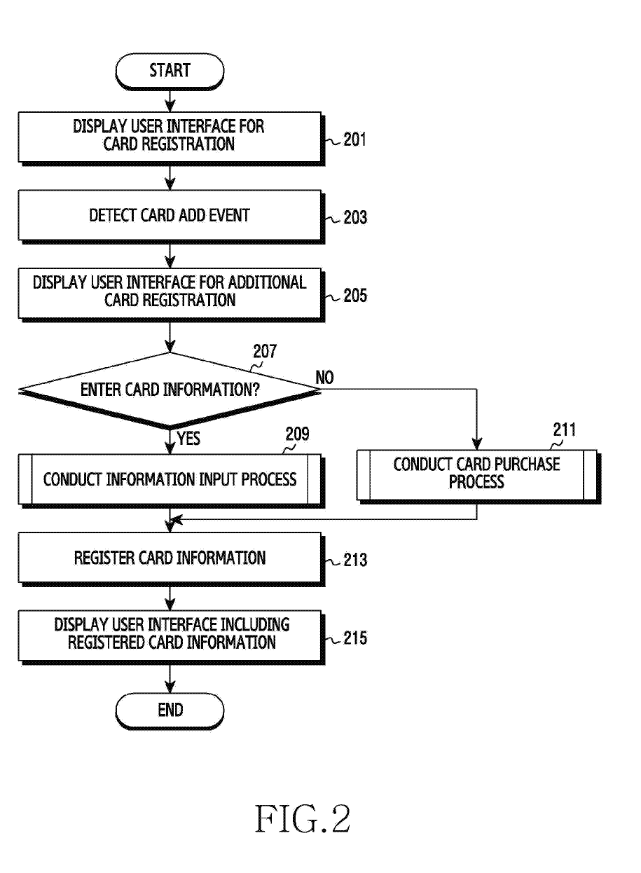

FIG. 2 is a flowchart illustrating a card registration method of an electronic device according to various embodiments.

Referring to FIG. 2, in operation 201, the electronic device 100 (e.g., the control unit 180) may display a user interface for card registration. For example, the user may execute a card-related application (e.g., a payment application, a membership application, a wallet application, a point application, etc.) in order to register his/her card in the electronic device 100. Alternatively, the user may execute the card-related application, to purchase a card. For example, a screen of the executed card-related application may be a user interface for the card registration. The card may include a credit card, a debit card, a private label credit card (PLCC) card, a check card, a gift certificate, a gift card, a bank debit card, a bank account, a membership card, a point card, a coupon, a resident registration card, a bank security card, and a driver's license. The user interface for the card registration may include a card add menu, an additional menu for card registration or purchase, information of the registered card, and available card information.

In operation 203, the control unit 180 may detect a card add event. For example, if the user selects (or touches) the “card add menu” in the user interface for the card registration, the control unit 180 may detect occurrence of the card add event. Alternatively, if the user selects the available card information in the user interface for the card registration, the control unit 180 may detect occurrence of the card add event.

In operation 205, the control unit 180 may display a user interface for additional card registration. For example, the user interface for the additional card registration may include an information input menu allowing the user to directly enter card information, or a card purchase menu for purchasing a card. The user may select either the information input menu or the card purchase menu. In so doing, if not desiring the additional card registration, the user may select a cancel button or a back button.

In operation 207, the control unit 180 may determine which menu is selected in the user interface for the additional card registration. For example, the control unit 180 may perform operation 209 if the information input menu is selected, and perform operation 211 if the card purchase menu is selected.

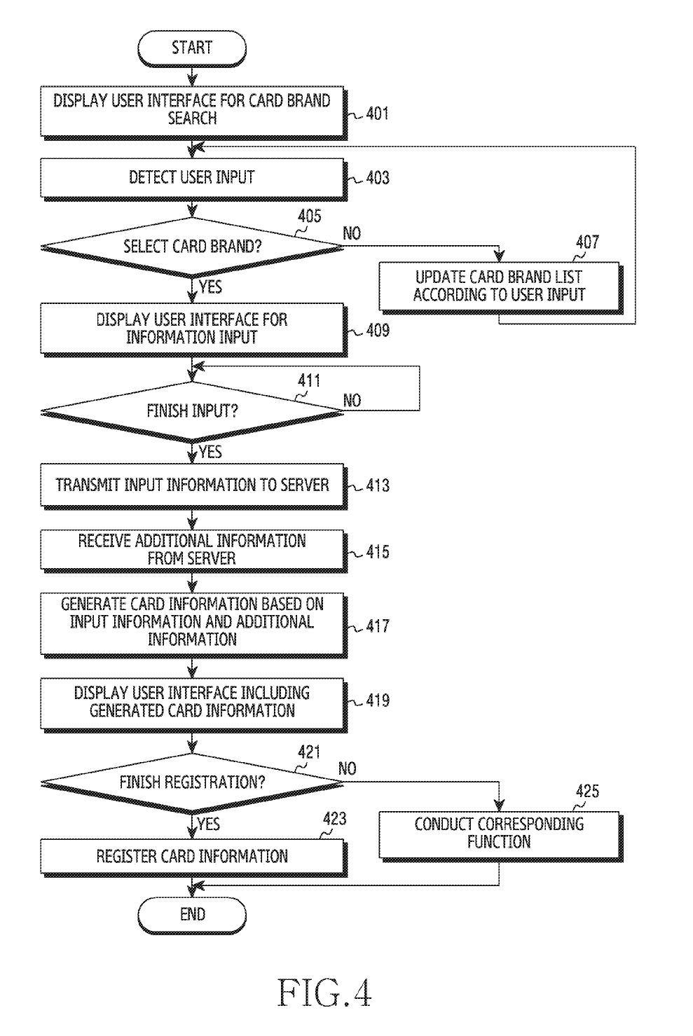

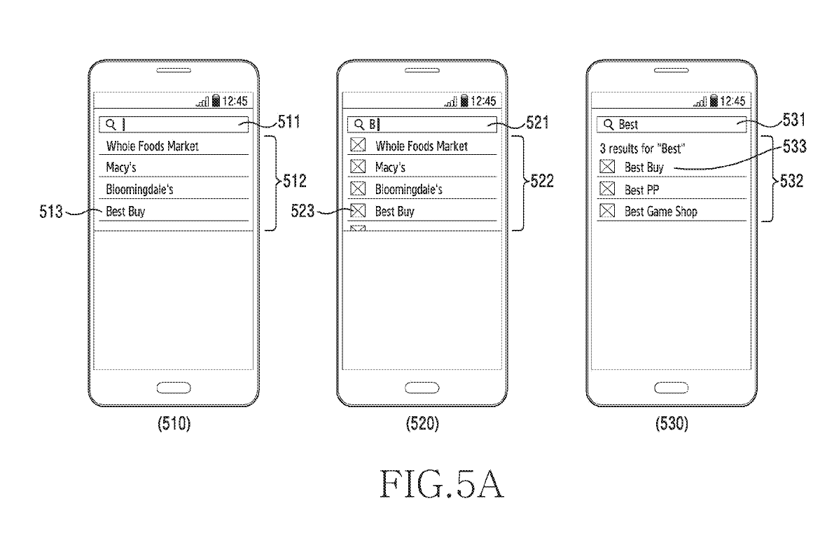

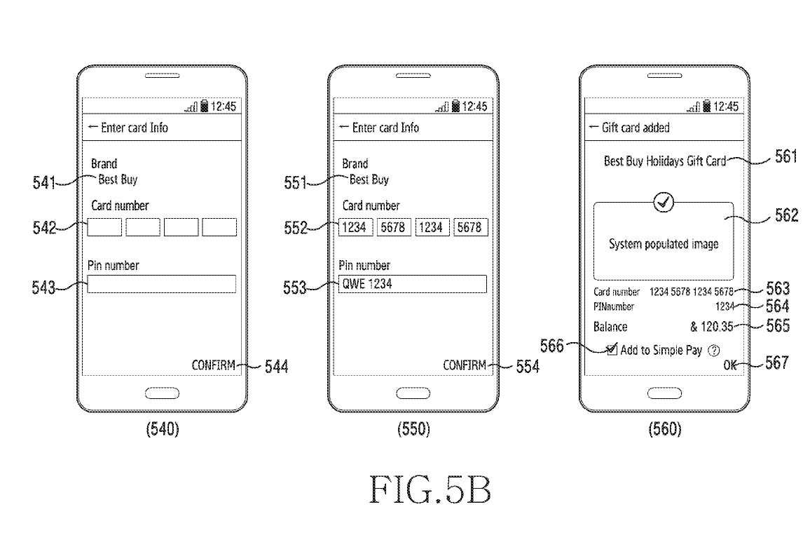

In operation 209, the control unit 180 may perform an information input process allowing the user to directly enter the card information. If the user directly inputs, the card may be a card possessed by the user. For example, the information input process may receive from the user, at least one of a card brand, a card number, or a personal identification number (PIN). The control unit 180 may transmit the entered input information to a server (e.g., a card company server) and receive additional information from the server. The control unit 180 may generate card information using the input information and the additional information. Hence, according to various embodiments, if the user enters only the card brand, the card number, and the PIN number, the control unit 180 may generate the card information by automatically receiving other information for the card registration from the server, and thus improve user convenience. The information input process shall be described in detail in FIG. 4 and FIG. 5A through FIG. 5C.

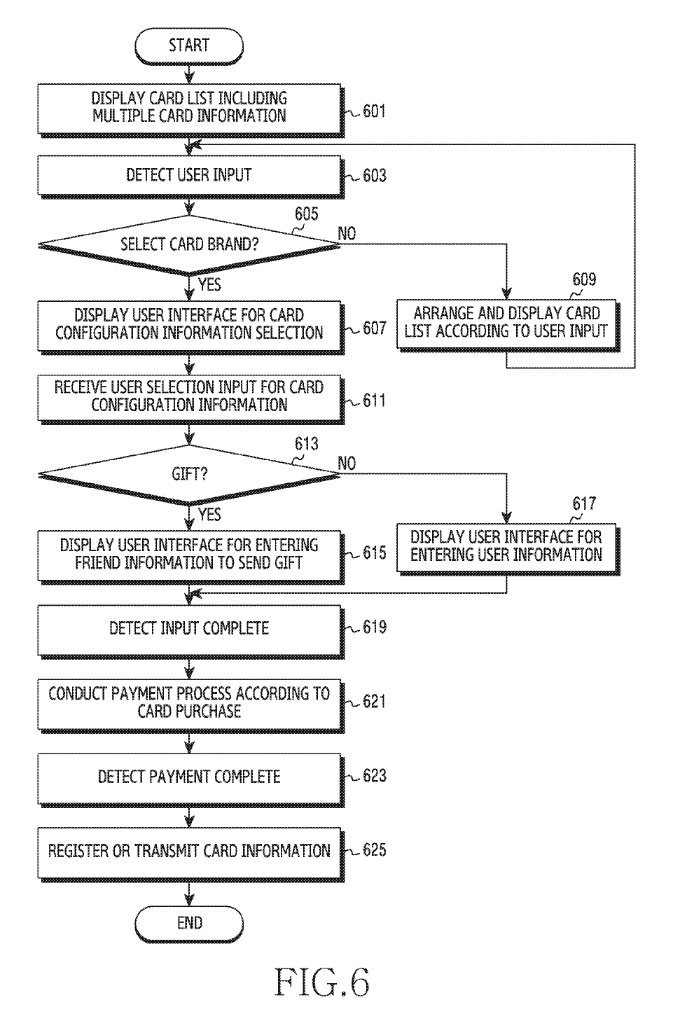

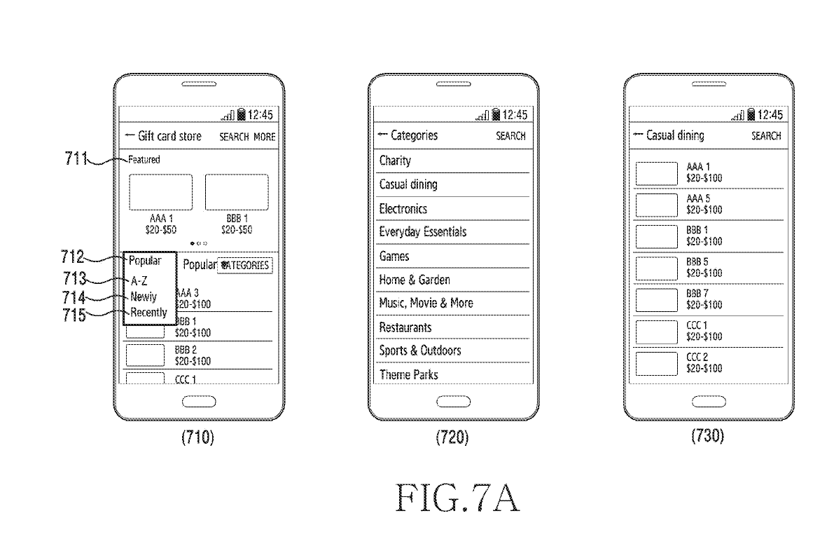

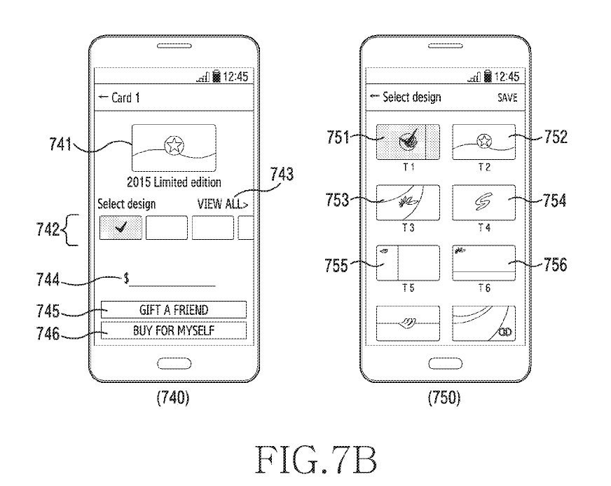

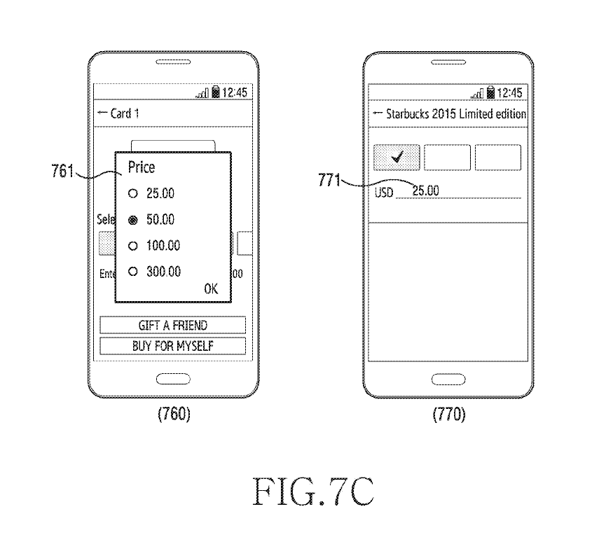

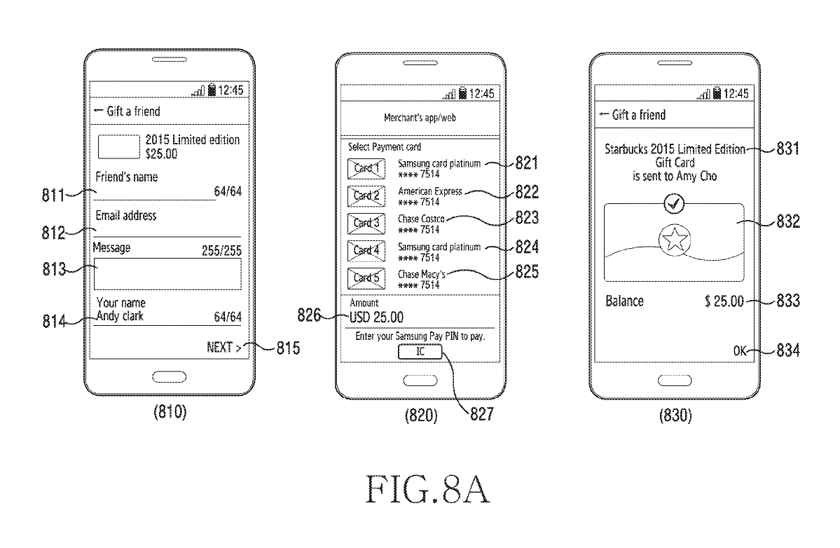

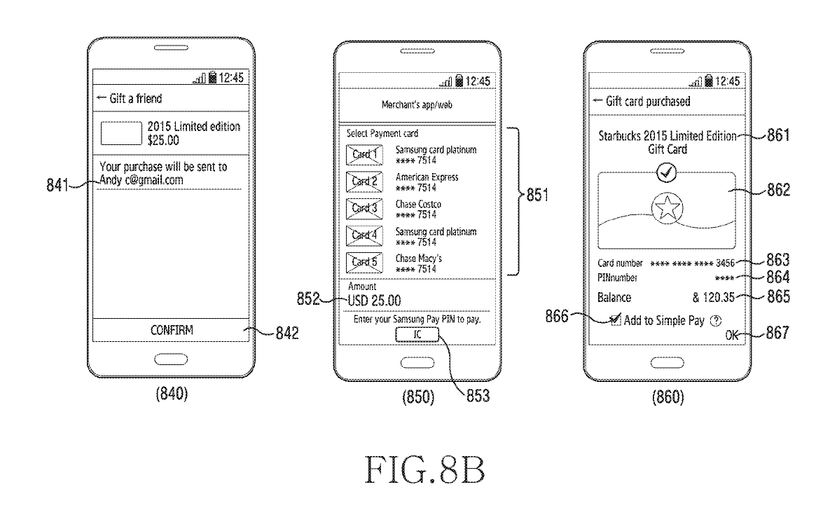

In operation 211, the control unit 180 may perform a card purchase process for purchasing a card. For example, the card purchase process may receive from the user at least one of the card brand, an image, and an amount, and, if the user completes payment for the card purchase, generate card information. The card purchase process shall be described in detail in FIG. 6, FIG. 7A through FIG. 7C, and FIG. 8A and FIG. 8B.

In operation 213, the control unit 180 may register the card information. For example, the control unit 180 may register the card information generated by conducting the information input process, in an application relating to the user's card. Alternatively, the control unit 180 may register card information purchased using the card purchase process, in the application relating to the user's card.

In operation 215, the control unit 180 may display a user interface including the registered card information. For example, the user interface including the registered card information may add the registered card information to the user interface displayed in operation 201. For example, if the user interface displayed in operation 201 includes one card information, the user interface displayed in operation 215 may include three card information. Alternatively, the user interface including the registered card information may display only the registered card information. For example, the user interface including the registered card information may include at least one of a card name, a card image, a card number, a PIN number, a card amount, and a card owner name.

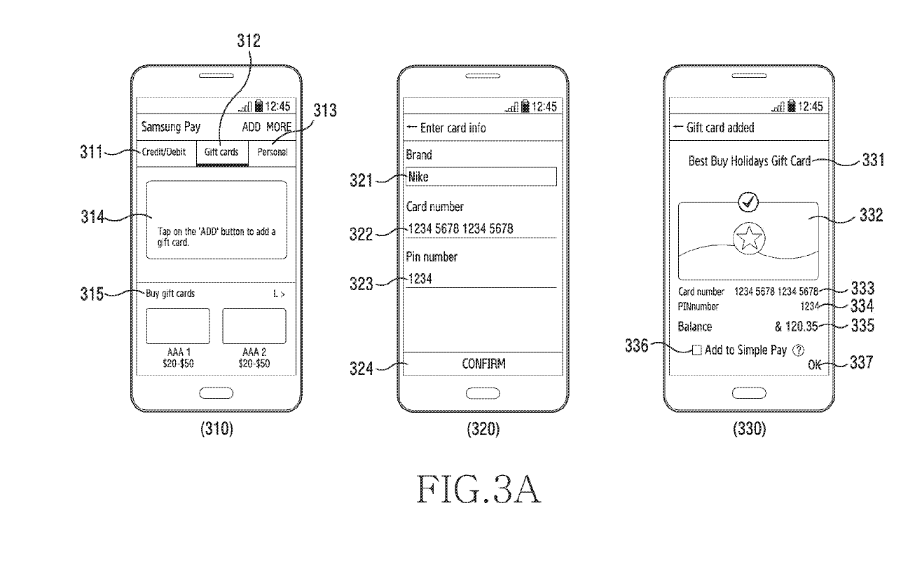

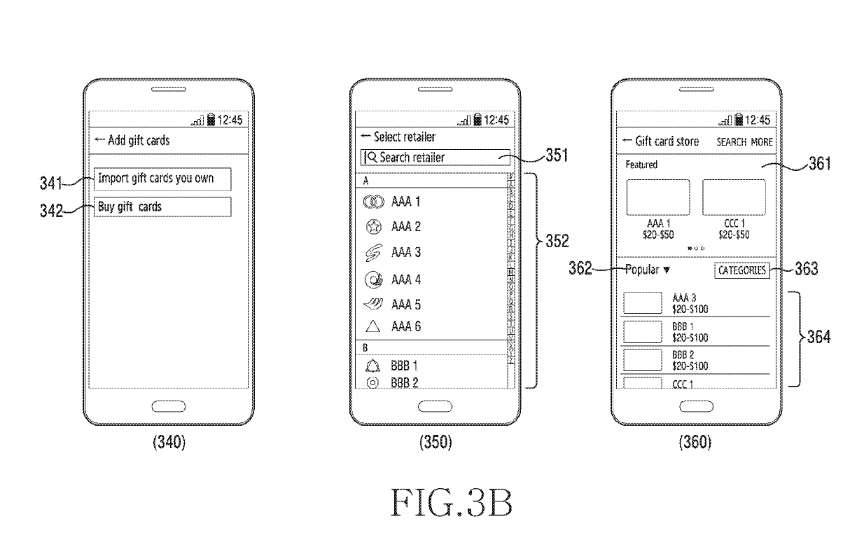

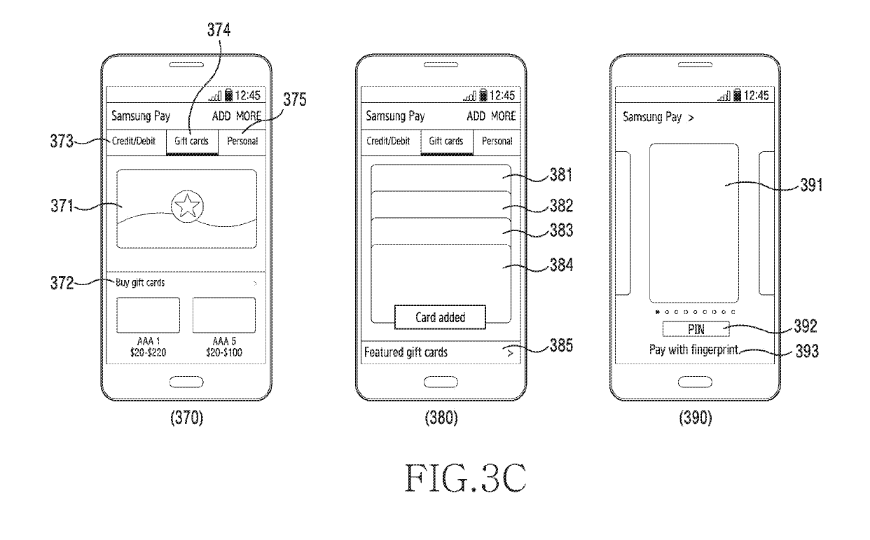

FIGS. 3A through 3C are diagrams illustrating an example of a user interface relating to card registration according to various embodiments.

FIG. 3A depicts a user interface for card registration.

Referring to FIG. 3A, a reference numeral ‘310’ depicts the user interface for the card registration. The user interface 310 may be displayed if an application relating to a card (or an electronic card) is executed and initially entered. The user interface 310 may include an add menu (e.g., ADD) for adding a card, and an additional menu (e.g., MORE) regarding the card registration or purchase, at the top. Also, the user interface 310 may include a menu for classifying and showing cards based on a type. For example, the user interface 310 may include tabs such as a Credit/Devit 311, a Gift Cards 312, and a Personal 313. If each tab is touched, the control unit 180 may display a card corresponding to a corresponding classification. For example, the Credit/Devit 311 may include a credit card, a debit card, a PLCC card, a check card, a bank withdraw card, a band account, and so on. For example, the Gift Cards 312 may include a gift certificate, a gift card, a membership card, a point card, a coupon, and so on. For example, the Personal 313 may include a resident registration card, a bank security card, a driver's license, and so on.

In the drawing, if the tab of the Gift Cards 312 is selected, the user interface 310 is shown. If a card image 314 is selected, the control unit 180 may display a user interface as if the card add menu is selected, for example, a user interface for additional card registration. If a card in a Buy gift cards 315 is selected, the control unit 180 may display a user interface for the card purchase.

A reference numeral ‘320’ depicts a user interface for entering card information. The user interface 320 may include items for entering a card brand 321, a card number 322, and a PIN number 323. An input window for entering information is displayed below the item, and the user may enter information by placing a cursor in the input window. For example, the control unit 180 may receive the card brand 321, the card number 322, or the PIN number 323 through the user input unit 120. The card brand 321 may be Nike, the card number 322 may be 1234 5678 1234 5678, and the PIN number 323 may be 1234. If the information input ends, the user may select (or touch) a CONFIRM 324. When the CONFIRM 324 is selected, the control unit 180 may determine that the information input is done. The control unit 180 may transmit the input information to a card company server through the wireless communication unit 110.

A reference numeral ‘330’ depicts a user interface including the registered card information. The user interface 330 may include a card name 331, a card image 332, a card number 333, a PIN number 334, a card amount 335, and a simple pay registration 336. The control unit 180 may receive additional information from the card company server in response to the input information. For example, the additional information may include at least one of the card name 331, the card image 332, and the card amount 335. Hence, according to the present invention, if the user enters only the card brand 321, the card number 322, and the PIN number 323, the card information may be generated by receiving other information required to configure card information, from the card company server. The card information may include the card name 331, the card image 332, the card number 333, the PIN number 334, or the card amount 335.

The simple pay may make the payment without executing the card-related application. If registered in the simple pay, the user may fetch the registered card information and make the payment in a lock screen or a home screen without executing the card-related application. By checking a check box of the simple pay registration 336, the user may register the card information in the card-related application and the simple pay. Alternatively, if not checking the check box of the simple pay registration 336, the user may make the payment by executing the card-related application though the card information is not registered in the simple pay. If an OK 337 is selected in the user interface 330, the control unit 180 may determine that the card information registration is completed. Upon determining the card information registration complete, the control unit 180 may display a user interface including the registered card information in the user interface 310 for the card registration.

FIG. 3B depicts a user interface for additional card registration.

Referring to FIG. 3B, a reference numeral ‘340’ depicts a user interface provided if the add menu is selected in the user interface 310 of FIG. 3A. The user interface 340 may include an information input menu 341 and a card purchase menu 342. The user may directly enter card information in the information input menu 341. For example, the user may select the information input menu 341 to enter his/her own card information. The card purchase menu 342 may allow the user to purchase a card for himself/herself or to present a card to a friend.

If the information input menu 341 is selected, the control unit 180 may display a user interface 350 for the information input. For example, the user interface 350 for the information input may be a card brand search page for searching for a card brand. The user interface 350 for the information input may include an input window 351 for entering the card brand to search, and a card brand list 352. The card brand list 352 may be displayed in an alphabetical order or in a user's personalized order.

If the card purchase menu 342 is selected, the control unit 180 may display a user interface 360 for the card purchase. The user interface 360 for the card purchase may display a first card list 361 and a second card list 634. The first card list 361 may include card information specialized for the user based on a user's use history. Alternatively, the first card list 361 may be card information purchased the most, or latest card information updated. The second card list 364 may include card information displayed in a particular order, such as alphabet, newly added cards, or cards recently visited. If the user selects a Popular 362, the control unit 180 may arrange and display card information of the second card list 364 in the order selected by the user. If the user selects a Categories 363, the control unit 180 may display a category list of the cards. The category list may include card information classified based on the category.

FIG. 3C depicts a user interface including the registered card information.

Referring to FIG. 3C, if the card information registration is completed, the control unit 180 may display a user interface 370 including the registered card information. The user interface 370 including the registered card information may further include the card information registered in the user interface 310 of FIG. 3A. The user interface 370 including the registered card information may include tabs such as Credit/Devit 373, Gift Cards 374, and Personal 375. Also, the user interface 370 including the registered card information may include a card image 371 of the registered card information. Also, the user interface 370 including the registered card information may include a Buy gift cards tab 372.

A reference numeral ‘380’ depicts another example of a user interface including the registered card information. If a number of card information are registered before a new card is registered, the control unit 180 may display a user interface 380 where several card images are overlapped. That is, the user interface 380 may display the multiple card images by dimming them or overlaying a transparent layer. Alternatively, the user interface 380 may overlap and display text data of the card name, the card number, and the PIN number on the card image.

A reference numeral ‘390’ depicts a user interface executed in the payment. For example, if the user selects any one card information for the payment or a gesture for the payment is detected in the lock screen, the control unit 180 may display the user interface 390 for the payment. The user interface 390 for the payment may include a card image 391, a card number, a PIN number 392, and user authentication request information 393 for the payment. The user interface 390 for the payment may blur and display a screen before the payment by blowing or translucently processing other portion than the selected card image 391 in the payment. According to an embodiment, when the screen before the execution is displayed in part, some region may be displayed the same as the existing screen. For example, the card number and the PIN number 392 may be displayed by encrypting digits. For example, the user authentication request information 393 for the payment may include a guide for receiving a fingerprint from the user.

FIG. 4 is a flowchart illustrating a card information input method of an electronic device according to various embodiments.

Referring to FIG. 4, in operation 401, the electronic device 100 (e.g., the control unit 180) may display a user interface for card brand search. The user interface for the card brand search may include an input window for entering a card brand to search for, and a card brand list. The card brand list may be displayed in the alphabetical order or in an order personalized for the user. The control unit 180 may set the user's personalized order based on a user's use history. For example, the personalized order may include at least one of a card brand recently purchased by the user, a card brand recently used by the user, a card brand recently visited by the user, a card brand used or visited the most by the user, a card brand recently updated, a card brand recently added, a card brand in an ascending order of price, or a card brand in a descending order of price. The control unit 180 may collect the user's use history during a certain period, and set the user's personalized order based on the collected use history.

In operation 403, the control unit 180 may detect a user input. For example, the control unit 180 may detect the user input which selects the input window in the user interface for the card brand search. Alternatively, the control unit 180 may detect the user input which selects one card brand of the card brand list in the user interface for the card brand search.

In operation 405, the control unit 180 may determine whether the user input is the input which selects the card brand. For example, if the user input is the input which selects the card brand, the control unit 180 may perform operation 409. If the user input is not the input which selects the card brand, the control unit 180 may perform operation 407.

If the user input is not the input which selects the card brand, the control unit 180 may update the card brand list according to the user input in operation 407. For example, if detecting the user input which selects the input window in the user interface for the card brand search, the control unit 180 may arrange and display the card brand list as at least one of recently searched card brands, recently purchased card brands, and recently searched search words. The control unit 180 may update and display the card brand list according to the user input, and then return to operation 403.

The control unit 180 may determine whether to perform operation 407 or operation 409 by carrying out operation 403 and operation 405. For example, if a second user input is detected, the control unit 180 may perform operation 405 and thus perform operation 407 or operation 409. In operation 407, the control unit 180 may update the card brand list according to the second user input. For example, if the second user input is a character input (e.g., alphabet, Hangeul, language of a country, number), the control unit 180 may arrange and display the card brand list according to the input character. For example, if the alphabet ‘a’ is input as the second user input, the control unit 180 may arrange and display card brands starting with ‘a’ or card brands including ‘a’ in the ascending order. The control unit 180 may update and display the card brand list according to the second user input, and then return to operation 403.

If the user input is the input selecting the card brand, the control unit 180 may display a user interface for information input in operation 409. For example, if the user input is the input selecting any one card brand of the card brand list in the user interface for the card brand search, the control unit 180 may display the user interface for the information input. The user interface for the information input may include a card brand input window, a card number input window, a PIN number input window, and a CONFIRM button. For example, if the card brand is selected, the user interface for the information input may include a card brand name of the selected card brand in the card brand input window, and place the cursor in the card number input window. The user may enter the card number or the PIN number by moving the cursor to the card number input window or the PIN number input window. While it is described that the user first selects the card brand and enters the card number and the PIN number in FIG. 4, the card number and the PIN number may be entered first and then the card brand may be selected.

In operation 411, the control unit 180 may determine whether the information input is finished. For example, if the information (card brand, card number, and PIN number) input is done, the user may finish the information input by selecting a button (or key) corresponding to “CONFIRM”, “FINISH” or “OK”. If the button corresponding to “CONFIRM”, “FINISH” or “OK” is selected in the user interface for the information input, the control unit 180 may determine that the information input is done.

In operation 413, the control unit 180 may transmit the input information to a server (e.g., a card company server) through the wireless communication unit 110. The input information may include at least one of the card brand name, the card number, and the PIN number. The card company server may determine whether the input information is valid. For example, the card company server may store card information (e.g., the card brand name, the card number, the PIN number, the card amount, etc.) issued (or sold) to the user, in a card information database. Hence, the card company server may determine whether the input information is stored in the card information database, and determine that the input information is not valid if the input information is not stored in the card information database. In this case, the card company server may notify the electronic device 100 of the invalid input information. In this case, the control unit 180 may display a message to re-enter the information because the card number or the PIN number is invalid, in the user interface for the information input.

Alternatively, if the input information is stored in the card information database, the card company server may determine the valid input information. In this case, the card company server may search for additional information corresponding to the input information, and transmit the searched additional information to the electronic device 100.

In operation 415, the control unit 180 may receive the additional information from the server. The additional information corresponds to the input information, and may include at least one of, for example, the card name, the card image, and the card amount.

In operation 417, the control unit 180 may generate card information based on the input information and the additional information. The card information is information required to register the card in the electronic device 100, and may include at least one of, for example, the card name, the card image, the card number, the PIN number, the card amount, and the card owner name. According to various embodiments, if the user enters only the card brand, the card number, and the PIN number, the control unit 180 may automatically generate the card information by receiving the additional information from the server.

In operation 419, the control unit 180 may display a user interface including the generated card information. For example, the user interface including the generated card information may include at least one of the card name, the card image, the card number, the PIN number, the card amount, and the card owner name. Also, the user interface including the generated card information may include an item for selecting whether to register the generated card information in the simple pay, and a CONFIRM button.

In operation 421, the control unit 180 may determine whether the registration of the generated card information is finished. The user interface including the generated card information may include a button corresponding to “CONFIRM”, “FINISH”, or “OK” and a button corresponding to “CANCEL”, “RETURN”, “BACK”. If the button corresponding to “CONFIRM”, “FINISH”, or “OK” is selected in the user interface including the generated card information, the control unit 180 may determine that the card information registration is finished.

If determining the registration finished, the control unit 180 may perform operation 423. If determining the registration not finished, the control unit 180 may perform operation 425.

In operation 423, the control unit 180 may register the generated card information. For example, the control unit 180 may register the generated card information in a card-related application. Hence, by executing the card-related application, the user may identify the generated card information. For example, the user may make payment with the generated card information by executing the card-related application. Alternatively, if the generated card information is registered in the simple pay, the user may make payment by fetching the generated card information in a lock screen or a home screen without executing the card-related application.

In operation 425, the control unit 180 may perform a corresponding function. For example, the control unit 180 may determine that the button corresponding to “CANCEL”, “RETURN”, “BACK” is selected, and return to the first step (e.g., operation 401) or return to the previous step (e.g., operation 409). Alternatively, the control unit 180 may terminate according to a user selection, or display the initial screen if the card-related application is executed.

FIGS. 5A and 5B are diagrams illustrating an example of a user interface relating to card information input according to various embodiments.

FIG. 5A depicts a user interface for updating a card brand list according to a user input.

Referring to FIG. 5A, a reference numeral ‘510’ is a user interface provided if a cursor is placed in an input window of the user interface for the card brand search. For example, if the cursor is placed in the input window 511, the control unit 180 may display a card brand list 512 in an order personalized for the user. For example, the card brand list 512 may include card brands arranged in the ascending order based on recently searched card brands, recently purchased card brands, and recently searched search words.

The user may select a card brand 513 in the card brand list 512. If the card brand 513 is selected in the card brand list 512, the control unit 180 may display a user interface 540 of FIG. 5B. That is, the control unit 180 may display a user interface (e.g., 540) for entering a card number and a PIN number because the card brand is selected, rather than displaying a user interface (e.g., 520, 530) by arranging the card brand list according to a character entered in the input window 511.

A reference numeral ‘520’ depicts a user interface provided if the user enters the alphabet “B”. For example, if the alphabet “B” is entered in the input window 521, the control unit 180 may display a card brand list 522 which arranges card brands starting with the alphabet “B” and card brands including the alphabet “B” in the ascending order. If a card brand 523 is selected in the card brand list 522, the control unit 180 may display a user interface 540 of FIG. 5B. That is, the control unit 180 may display the user interface (e.g., 540) for entering the card number and the PIN number, rather than displaying the user interface (e.g., 530) which arranges and displays the card brand list according to the character entered in the input window 521.

A reference numeral ‘530’ depicts a user interface provided if the user enters the alphabet “Best”. For example, if “Best” is entered in the input window 531, the control unit 180 may display a card brand list 532 which arranges card brands starting with the alphabet “Best” and card brands including the alphabet “Best” in the ascending order. Also, the control unit 180 may also display a message notifying that three card brands are obtained with “Best”. If a card brand 533 is selected in the card brand list 532, the control unit 180 may display the user interface 540 of FIG. 5B.

FIG. 5B depicts the user interface for entering information.

Referring to FIG. 5B, the reference numeral ‘540’ depicts the user interface including a card brand input window 541, a card number input window 542, a PIN number input window 543, and a CONFIRM button 544. The card brand input window 541 may include the card brand “Best Buy” which is selected in FIG. 5A. The user may enter the card number or the PIN number by placing the cursor in the card number input window 542 or the PIN number input window 543. The control unit 180 may disable and display the CONFIRM button 544 until information is entered in all of the card brand, the card number, or the PIN number. The disabled displaying may indicate that, although a user input which presses the CONFIRM button 544 is detected, the control unit 180 does not perform an operation corresponding to the detected user input. That is, the control unit 180 may ignore the user input on the disabled button.

A reference numeral ‘550’ depicts a user interface where all of a card brand input window 551, a card number input window 552, and a PIN number input window 553 are filled with information. For example, the card brand input window 551 may include the card brand “Best Buy”, the card number input window 552 may include the card number “1234 5678 1234 5678”, and the PIN number input window 553 may include a PIN number “QWE 1234”. If all of the card brand input window 551, the card number input window 552, and the PIN number input window 553 are filled out, the control unit 180 may enable a CONFIRM button 554. Enabling may indicate that the control unit 180 performs an operation corresponding to a user input which presses the CONFIRM button 554. If the user selects (or touches) the CONFIRM button 554, the control unit 180 may transmit the input information (e.g., Best Buy, 1234 5678 1234 5678, QWE 1234) to the card company server. The card company server may transmit additional information corresponding to the input information, to the electronic device 100.

According to various embodiments, if not detecting additional information corresponding to the input information, or if the input information is not stored in a card information database, the card company server may notify the invalid input information to the electronic device 100. In this case, the control unit 180 may display a message to re-enter the information because the card number or the PIN number is invalid, in the user interface for the information input.

A reference numeral ‘560’ depicts a user interface including card information generated based on the input information and the additional information. The user interface 560 may include a card name 561, a card image 562, a card number 563, a PIN number 564, a card amount 565, a simple pay registration 566, and an OK button 567. The card name 561, the card image 562, and the card amount 565 may be additional information received from the card company server. Hence, the control unit 180 may generate the card information by receiving from the card company server, other information for the card registration than the information entered by the user.

If a check box of the simple pay registration 566 is checked, the control unit 180 may register the generated card information in a card-related application and register as the simple pay. Alternatively, if the check box of the simple pay registration 566 is not checked, the control unit 180 may register the card information only in the card-related application, without registering as the simple pay. If the OK 567 is selected in the user interface 560, the control unit 180 may determine that the card information registration is finished. If determining that the card information registration is finished, the control unit 180 may display a user interface including the registered card information, in the user interface 310 for the card registration.

FIG. 6 is a flowchart illustrating a card purchase method of an electronic device according to various embodiments.

Referring to FIG. 6, in operation 601, the electronic device 100 (e.g., the control unit 180) may display a card list including a plurality of card information. For example, if the user selects the card purchase menu 342 in the user interface 340 of FIG. 3B, the control unit 180 may display a user interface for the card purchase. The user interface for the card purchase may indicate card information available for the user. For example, the card list including the plurality of the card information may include a first card list including card information specialized for the user based on a user's use history or a second card list including card information arranged in a certain order. Also, the user interface for the card purchase may further include a Popular button for arranging the card information of the second card list in a user's desired order or a Categories button for arranging per category.

In operation 603, the control unit 180 may detect a user input. For example, the control unit 180 may detect a user input which selects card information in any one of the card lists. Alternatively, the control unit 180 may detect a user input which scrolls the first card list or scrolls the second card list. Alternatively, the control unit 180 may detect a user input which selects the Popular button for arranging the card information of the second card list in the user's desired order, or the Categories button for arranging per category.

In operation 605, the control unit 180 may determine whether the user input selects a card brand. For example, the control unit 180 may perform operation 607 if the user input selects the card band, and perform operation 609 if the user input does not select the card band.

If the user input does not select the card band, the control unit 180 may arrange and display the card list according to the user input in operation 609. For example, if the user input scrolls the first card list, the control unit 180 may scroll and display the first card list according to the user input. If the user input scrolls the second card list, the control unit 180 may scroll and display the second card list according to the user input. Alternatively, if the user input selects the Popular button, the control unit 180 may arrange and display the second card list in the order selected by the user. If the user input selects the Categories button, the control unit 180 may display a category list of the cards. The category list may be displayed in the second card list, or may be displayed by switching a page in a page for the card purchase. The control unit 180 may arrange and display the card list according to the user input, and then return to operation 603.

If the user input selects the card brand, the control unit 180 may display a user interface for card configuration information selection in operation 607. For example, the user interface for the card configuration information selection may select a card type, a card image, a card amount, and so on.

In operation 611, the control unit 180 may receive a user selection input for the card configuration information. For example, the card type may indicate different types of cards provided from one card brand. The control unit 180 may display a plurality of card types, and receive from the user, any one card type of the multiple card types. The card image may be displayed as an image of the card when the card information is displayed on the display 131. The control unit 180 may be displayed a card image list including a plurality of card images, and receive from the user, any one card image of the card image list. If the card is a gift card, the card amount may be an amount available like cash. The control unit 180 may display a card amount list including of available card amounts of different amounts, and receive from the user, any one card amount of the card amount list. Alternatively, the control unit 180 may also receive a desired card amount directly from the user.

In operation 613, the control unit 180 may determine whether to preset the card. For example, the control unit 180 may display an item (e.g., a gift menu) for presenting the card to a friend (or an acquaintance) or an item (e.g., a buy menu) for purchasing a card for the user, in the user interface for the card configuration information selection. For example, after entering all of the card configuration information, the user may select the gift menu or the buy menu. Alternatively, after selecting the gift menu or the buy menu, the user may enter the card configuration information.

The control unit 180 may perform operation 615 if the gift menu is selected, and perform operation 617 if the buy menu is selected.

First, in operation 615, the control unit 180 may display a user interface for entering friend information to present the card. For example, the user interface for entering the friend information to present the card may include a friend name input window, a friend contact input window, a gift message input window, and a user name input window (e.g., a name of a person who sends the gift). The friend contact input window may be an item for entering a friend's email address or a friend's phone number (e.g., a phone number of an electronic device). The gift message input window may be an item for entering contents to send from the user to the friend when the user presents the card. At this time, if the friend is registered in a phone book of the electronic device 100, when the name of the friend is entered, contacts of the friend may be entered automatically.

In operation 617, the control unit 180 may display a user interface for entering user information. For example, the user interface for entering the user information may include a user contact input window. The user contact input window may be an item for entering a user's email address or a user's phone number. According to various embodiments, if the user's contact (e.g., an email address, a phone number) is registered in the electronic device 100, the registered user contact may be automatically entered in the user interface for entering the user information. Alternatively, if the user's contact is registered in setting information of a card-related application, the registered user contact may be automatically entered in the user interface for entering the user information.

In operation 619, the control unit 180 may detect that the information input is finished. For example, the user interface for entering the information (e.g., friend information, or user information) may include a button corresponding to “CONFIRM”, “OK”, “SAVE”, or “NEXT”. If the button corresponding to “CONFIRM”, “OK”, “SAVE”, or “NEXT” is selected, the control unit 180 may determine that the information input is completed.

In operation 621, the control unit 180 may perform a payment process according to card purchase. For example, the control unit 180 may display a card list including card information registered in the card-related application, and receive one card information selected from the card list. The control unit 180 may make the payment using the selected card information. For example, the control unit 180 may transmit card information (e.g., a user name, a card number, an expiration date, an authentication value (e.g., a card verification value (CVV), or a signature) to the card company server of the selected card information or a value add network (VAN), and receive a payment authorization result (e.g., approval or rejection) from the card company server or the VAN. The method for making the payment in the electronic device 100 is the well-known technique and thus its detailed description shall be omitted here.

In operation 623, the control unit 180 may detect payment complete. For example, if the payment authorization result received from the card company server or the VAN is the approval, the control unit 180 may finish the payment process according to the card purchase. Alternatively, if the payment authorization result received from the card company server or the VAN is the rejection, the control unit 180 may re-perform the payment process according to the card purchase. Alternatively, if the payment authorization result received from the card company server or the VAN is the rejection, the control unit 180 may finish the payment process according to the card purchase.

In operation 625, the control unit 180 may register or transmit the purchased card information (e.g., a card number, a PIN number, a card image, a card amount, etc.). For example, if the user information is entered in the user interface for the information input (e.g., operation 617), the control unit 180 may register the purchased card information in the card-related application. Alternatively, if the friend information is entered in the user interface for the information input (e.g., operation 615), the control unit 180 may transmit the purchased card information to a web server corresponding to the email address, or to an electronic device corresponding to the phone number, through the wireless communication unit 110.

FIGS. 7A through 7C are diagrams illustrating an example of a user interface relating to card purchase according to various embodiments.

FIG. 7A shows the user interface relating to the card purchase.

Referring to FIG. 7A, a reference numeral ‘710’ depicts the user interface relating to the card purchase. The user interface 710 for the card purchase may include a card list including a plurality of card information. The card list may be divided into a first card list 711 and a second card list. The first card list 711 may include card information specialized for the user based on a user's use history. Alternatively, the first card list 711 may be card information purchased the most or card information updated the most recently. The second card list may include the card information displayed in a specific order. If the user selects a Popular 712, the control unit 180 may display an order list. The order list may include orders such as alphabet 713, Newly Added card 714, and Recently Visited card 715. The control unit 180 may arrange and display the card information of the second card list in the user's selected order.

A reference numeral ‘720’ is related to a user interface which displays a category list of cards. If the Categories is selected in the user interface 710 for the card purchase, the control unit 180 may display the user interface 720 including the category list for the card. A reference numeral ‘730’ is related to a user interface displaying a card list including card information corresponding to Casual dining. If the Casual dining is selected in the user interface 720 including the category list, the control unit 180 may display a card list including the card information corresponding to the Casual dining.

FIG. 7B depicts a user interface for card configuration information selection.

Referring to FIG. 7B, a reference numeral ‘740’ depicts the user interface for the card configuration information selection. The user interface 740 for the card configuration information selection may include an image 741 of the selected card, a card image list 742, a VIEW ALL 743, and a card amount item 744. The selected card image 741 may be a card image selected by default when the card brand is selected. If detecting a user input which scrolls in the card image list 742, the control unit 180 may scroll and display card images corresponding to the user input. The user may select one desired card image by scrolling the card image list 742. The VIEW ALL 743 displays all the card images of the card image list 742. The card amount item 744 may be an amount to purchase. The user interface 740 for the card configuration information selection may further include a gift menu 745 and a buy menu 743. If the gift menu 745 is selected, the control unit 180 may display a user interface for entering friend information to present the card. If the buy menu 743 is selected, the control unit 180 may display a user interface for entering the user information.

A reference numeral ‘750’ shows a user interface including a plurality of card images. If the VIEW ALL 743 is selected in the user interface 740 for the card configuration information selection, the control unit 180 may switch the page to the user interface 750 including a plurality of card images 751 to 756 in the user interface 740 for the card configuration information selection. The user interface 750 may include a card image list including the card images 751 to 756. The card image list may include different card images, for example, a first card image 751, a second card images 752, a third card images 753, a fourth card images 755, and a fifth card image 756. The user may select one desired card image from the card images.

FIG. 7C depicts a user interface for selecting the card amount.

Referring to FIG. 7C, a reference numeral ‘760’ is related to a user interface displaying a card amount list 761 including an available card amount. If the cursor is placed on the card amount item 744 in the user interface 740 for the card configuration information selection, the control unit 180 may display the card amount list 761. The card money list 761 may define the available card amount per amount. The card amount list 761 may be provided in the form of a popup window on the user interface 740 for the card configuration information selection. Alternatively, the card amount list 761 may be displayed by switching the page in the user interface 740 for the card configuration information selection.

A reference numeral ‘770’ is related to a user interface for directly entering the card amount to purchase. If the cursor is placed on the card amount item 744 in the user interface 740 for the card configuration information selection, the control unit 180 may display a user interface 770 for manually entering the card amount. If the card amount input item 771 is selected in the user interface 770 for manually entering the card amount, the control unit 180 may display a numeric keypad so that the user may directly enter the card amount. The user may enter a desired amount to buy, by placing the cursor on the card amount item 771.

According to various embodiments, if the cursor is placed on the card amount item 744 in the user interface 740 for the card configuration information selection, the control unit 180 may display the card amount list 761 or the user interface 770 for manually entering the card amount. Whether to display the card amount list 761 or whether to display the user interface 770 for manually entering the card amount may be determined according to information which is set from a seller in the card registration.

FIGS. 8A and 8B are diagrams illustrating an example of a user interface relating to payment in card purchase according to various embodiments.

FIG. 8A depicts a user interface provided if a card is presented to a friend.

Referring to FIG. 8A, a reference numeral ‘810’ is related to a user interface for entering friend information to present a card. The user interface 810 for entering the friend information may include a friend name input window 811, a friend contact input window 812, a gift message input window 813, a user name input window 814, and a NEXT button 815. The friend name input window 811 may be an item for entering the name of the friend to present the card, and the friend contact input window 812 may be an item for entering a friend's email address or a friend's phone number (e.g., a phone number of an electronic device). The gift message input window 813 may be an item for entering contents to send when the user presents the card to the friend. The user name input window 814 may be an item for entering the user's name or the user's contact, who presents the card.

According to various embodiments, if the friend is registered in a phone book of the electronic device 100, when the friend name is input, the control unit 180 may automatically enter the friend's contact stored in the phone book. In addition, the control unit 180 may automatically enter the user's name or the user's contact in the user name input window 814. After finishing the information input, if the user selects the NEXT button 815 corresponding to “CONFIRM”, “OK”, “SAVE”, or “NEXT”, the control unit 180 may determine that the information input is done.

A reference numeral ‘820’ is related to a user interface for the payment according to the card purchase. If the NEXT button is selected in the user interface 810 for entering the friend information to send the gift, the control unit 180 may display the user interface 820 for the payment. The user interface 820 for the payment may include a card list including card information registered in a card-related application, a payment amount 826, and an authentication information input item 827. The card list may include first card information 821, second card information 822, third card information 823, fourth card information 824, and fifth card information 825. The payment amount 826 may be a card amount selected or entered by the user in the user interface for selecting the card amount of FIG. 7C. The authentication information input item 827 may be an item for entering user authentication information required for the payment. For example, the authentication information input item 827 may be a signature, a fingerprint, a password, and so on. If all the items in the user interface 820 for the payment are filled out, the control unit 180 may conduct a payment process according to the card purchase.

A reference numeral ‘830’ is related to a user interface provided when the payment according to the card gift is completed. The user interface 830 may include a message 831 notifying that the purchased card (Starbucks 2015 Limited Edition Gift Card) is presented to the friend (Amy cho), a presented card image 832, a card amount 833, and an OK button 834. If the OK button 834 is selected, the control unit 180 may transmit card information (e.g., the card number, the PIN number, the card image, the card amount, etc.) of the purchase card, to a web server corresponding to the email address entered in the friend contact input window 812. Alternatively, the control unit 180 may transmit the card information (e.g., the card number, the PIN number, the card image, the card amount, etc.) of the purchase card, to an electronic device corresponding to the phone number entered in the friend contact input window 812.

FIG. 8B depicts a user interface provided when the user purchases a card.

Referring to FIG. 8B, a reference numeral ‘840’ is related to a user interface for entering user information. The user interface 840 for entering the user information may include a user contact input window 841 and a CONFIRM button 842. The user contact input window 841 may be an item for entering the email address or phone number of the user. If the user selects (or touches) the user contact input window 841, the control unit 180 may display a keypad for inputting the contact. If the user email address input is required, the control unit 180 may display a character keypad. If the user phone number input is necessary, the control unit 180 may display a numeric keypad. Whether the email address input is needed or the phone number input is needed may be set variously according to a seller, a card type, a card purchase setting information, and so on.

According to various embodiments, if the user's contact (e.g., email address, phone number) is registered in the electronic device 100, the control unit 180 may automatically enter the registered user contact in the user contact input window 841. Alternatively, if the user contact is registered in setting information of the card-related application, the control unit 180 may automatically enter the registered user contact in the user contact input window 841.

A reference numeral ‘850’ is related to a user interface for the payment according to the card purchase. If the OK button 842 is selected in the user interface 840 for the user information input, the control unit 180 may display the user interface 850 for the payment. The user interface 850 for the payment may include a card list 851 including card information registered in the card-related application, a payment amount 852, and an authentication information input item 853. The user interface 820 for the payment is identical to the user interface 820 of FIG. 8A and accordingly its detailed descriptions shall be omitted.

A reference numeral ‘860’ is related to a user interface provided when the payment of the card purchase is completed. The user interface 860 may include information 861 about the purchased card (Starbucks 2015 Limited Edition Gift Card), a purchased card image 862, a card number 863, a PIN number 864, a card amount 865, simple pay registration 866, and an OK button 867. If the OK button 867 is selected, the control unit 180 may register the purchased card information in the card-related application. If the simple pay registration 866 is checked, the control unit 180 may also register the purchased card information in the simple pay.

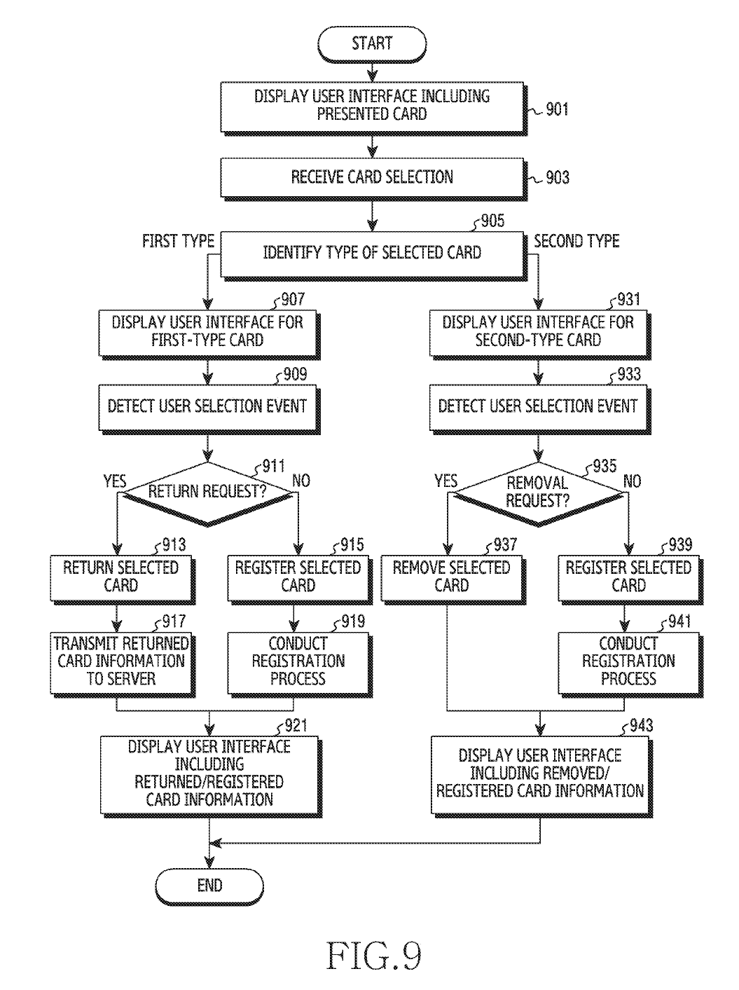

FIG. 9 is a flowchart illustrating a card removing method of an electronic device according to various embodiments.

Referring to FIG. 9, in operation 901, the electronic device 100 (e.g., the control unit 180) may display a user interface including a presented card. The control unit 180 may display a card list including card information of the presented card. The presented card may be randomly issued by a seller, or received from a friend. The card randomly issued to the seller and the card presented from the friend may differ in card type. For example, the card randomly issued to the seller may not be a card owned by the user before the user registers it. The card randomly issued to the seller may be a card of a first type, for example, returnable. The card presented from the friend may be a card owned by the user. Hence, the card presented from the friend may be a card of a second type, for example, nonreturnable. The card type may be set at the phase of card issue.

In operation 903, the control unit 180 may receive a card selection. For example, the control unit 180 may receive a user input which selects one card from the card list.

In operation 905, the control unit 180 may identify the type of the selected card. For example, the type may be classified into the first type which is returnable and the second type which is nonreturnable. The control unit 180 may provide a different user interface for each type of the card. If the type of the selected card is the first type, the control unit 180 may perform operation 907. If the type of the selected card is the second type, the control unit 180 may perform 931.

First, the card of the first type is explained.

For the first type, in operation 907, the control unit 180 may display a user interface relating to the first-type card. For example, the user interface relating to the first-type card may include a card image, a card amount, a card issue message, simple pay registration, a return menu (or button), and an add menu (or button). That is, since the first-type card is returnable, the control unit 180 may display the user interface including the return menu and the add menu. The return menu may return a randomly issued card back to a server. The add menu may possess a randomly issued card as its own.

In operation 909, the control unit 180 may detect a user select event. For example, the user may select either the return menu or the add menu. Alternatively, the user may select whether to register the simple pay, and then select either the return menu or the add menu. If either the return menu or the add menu is selected, the control unit 180 may perform operation 911.

In operation 911, the control unit 180 may determine whether the user selection event is a return request. For example, the control unit 180 may perform operation 913 if the user selects the return menu, and perform operation 915 if the user selects the add menu.

If the return menu is selected, in operation 913, the control unit 180 may return the selected card. In operation 917, the control unit 180 may transmit card information of the returned card, to a server (e.g., a card issuing server or a seller server) through the wireless communication unit 110. This is for the server to re-issue the returned card to other user. In operation 921, the control unit 180 may display a user interface with the card information of the returned card deleted. For example, the user interface with the card information deleted may delete the returned card information from the user interface displayed in operation 901.

If the add menu is selected, in operation 915, the control unit 180 may register the selected card. In operation 919, the control unit 180 may perform a registration process. The registration process registers the card information of the selected card in the card-related application. The card registration process has been explained in detail with reference to FIG. 2 and FIG. 4, and thus its detailed descriptions shall be omitted. In operation 921, the control unit 180 may display a user interface including card information of the registered card. For example, the user interface including the card information may add the registered card information to the user interface displayed in operation 901.

The card of the second type is now described.

For the second type, in operation 931, the control unit 180 may display a user interface relating to the second-type card. For example, the user interface relating to the second-type card may include a card image, a card amount, a card issue message, simple pay registration, a remove menu (or button), and an add menu (or button). That is, since the second-type card is nonreturnable, the control unit 180 may display the user interface including the remove menu and the add menu. The remove menu may remove the presented card without registering it in the card application. The add menu may register the presented card in the card application.

In operation 933, the control unit 180 may detect a user selection event. For example, the user may select either the remove menu or the add menu. Alternatively, the user may select whether to register the simple pay, and then select either the remove menu or the add menu. If either the remove menu or the add menu is selected, the control unit 180 may perform operation 935.

In operation 935, the control unit 180 may determine whether the user selection event is a remove request. For example, the control unit 180 may perform operation 937 if the user selects the remove menu, and perform operation 939 if the user selects the add menu.

If the remove menu is selected, in operation 937, the control unit 180 may remove the selected card. That is, the control unit 180 may not register the card information of the selected card in the card-related application. This is merely to not include the card information in the card-related application, not returning the presented card. In operation 943, the control unit 180 may display a user interface by removing the card information of the removed card. For example, the user interface with the card information removed may remove the selected card information from the user interface displayed in operation 901.

If the add menu is selected, in operation 939, the control unit 180 may register the selected card. In operation 941, the control unit 180 may perform a registration process. The registration process registers the card information of the selected card in the card-related application. The card registration process has been explained in detail with reference to FIG. 2 and FIG. 4, and thus its detailed descriptions shall be omitted. In operation 943, the control unit 180 may display a user interface including card information of the registered card. For example, the user interface including the card information may add the registered card information to the user interface displayed in operation 901.

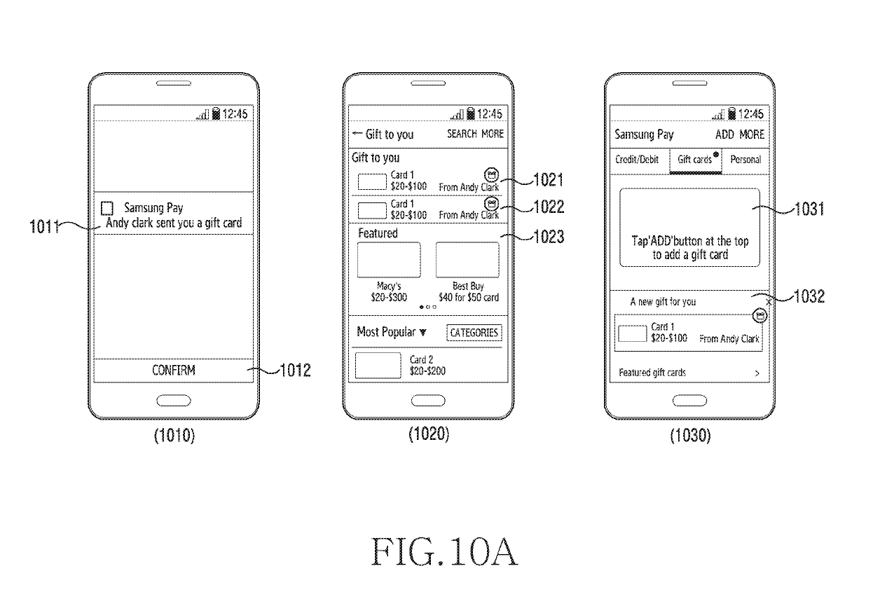

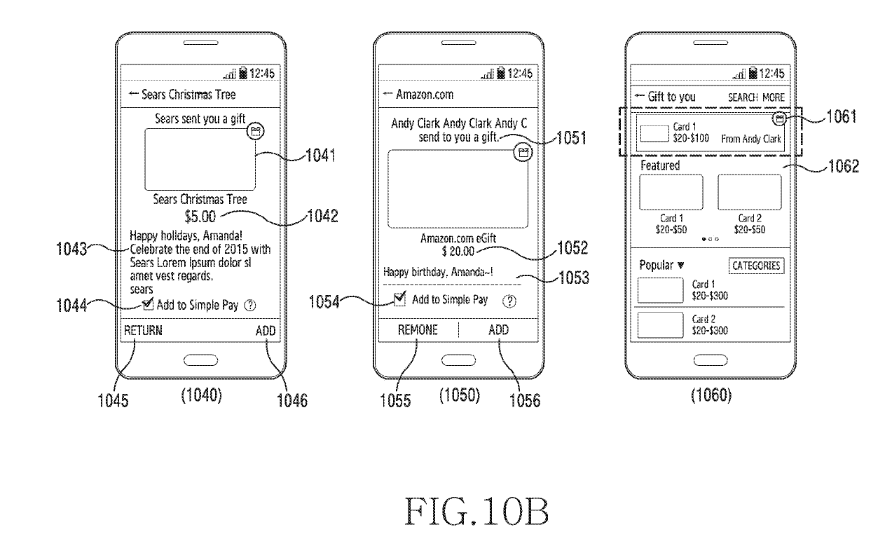

FIGS. 10A and 10B are diagrams illustrating an example of a user interface relating to card removal according to various embodiments.

FIG. 10A depicts a user interface including presented card information.

Referring to FIG. 10A, a reference numeral ‘1010’ is related to a user interface notifying that a card is presented. The card gift notification user interface 1010 may include a card gift message 1011 and a CONFIRM button 1012. The card gift message 1011 may include a name of a person who sends the card or presents the card. The card gift message 1011 may be displayed in the form of a popup window. For example, if receiving a card gift message from a server (e.g., a card issuing server or a web server), the control unit 180 may display the card gift message 1011, as the popup window, over a screen displayed in the display 131.

A reference numeral ‘1020’ is related to a user interface including the presented card information. For example, if the user executes a card-related application, the control unit 180 may display the user interface 1020 including the presented card information. The user interface 1020 including the presented card information may include a presented card list and a list 1023 of available card information. The presented card list may include first card information 1021 and second card information 1022. The user may select any one car of the presented card list, and return, remove, or register the card.

A reference numeral ‘1030’ is related to another example of a user interface including the presented card information. For example, if the user executes the card-related application, the control unit 180 may display the user interface 1030 including the presented card information. The user interface 1030 including the presented card information may include registered card information 1031 and presented card information 1032. By selecting the presented card information, the user may return, remove, or register the card.

FIG. 10B depicts a user interface according to a card type for card retrain, removal, or registration.

Referring to FIG. 10B, a reference numeral ‘1040’ is related to a user interface of a first-type card. For example, if the CONFIRM button 1012 is selected in the card gift notification user interface 1010 of FIG. 10A, the control unit 180 may identify the type of the presented card. If the identified type is the first type, the control unit 180 may display a user interface 1040 relating to a first-type card. Alternatively, if one card is selected in the user interface 1020 or 1030 including the presented card information of FIG. 10A, the control unit 180 may identify the type of the presented card. If the identified type is the first type, the control unit 180 may display a user interface 1040 relating to the first-type card. The user interface 1040 relating to the first-type card may include a card image 1041, a card amount 1042, a card issue message 1043, simple pay registration 1044, a return menu 1045, and an add menu 1046. If the return menu 1045 is selected, the control unit 180 may transmit the presented card to a sender, and may not register the card information in the card application. If the add menu 1046 is selected, the control unit 180 may register the card information of the presented card in the card application.

A reference numeral ‘1050’ is related to a user interface regarding the second-type card. For example, if the CONFIRM button 1012 is selected in the card gift notification user interface 1010 of FIG. 10A, the control unit 180 may identify the type of the presented card. If the identified type is the second type, the control unit 180 may display a user interface 1050 relating to the second-type card. Alternatively, if one card is selected in the user interface 1020 or 1030 including the presented card information of FIG. 10A, the control unit 180 may identify the type of the presented card. If the identified type is the second type, the control unit 180 may display the user interface 1050 relating to the second-type card. The user interface 1050 relating to the second-type card may include a card image 1051, a card amount 1052, a card issue message 1053, simple pay registration 1054, a remove menu 1055, and an add menu 1056. If the remove menu 1055 is selected, the control unit 180 may not register the card information of the presented card in the card application. If the add menu 1056 is selected, the control unit 180 may register the card information of the presented card in the card application.

A reference numeral ‘1060’ is related to a user interface which returns or removes the presented card without registering it. For example, if the second card information 1022 is selected and then returned or removed in the user interface 1020 of FIG. 10A, the control unit 180 may display a user interface 1060 with the second card information 1022 removed. The user interface 1060 may include first card information 1061 and a card list 1062. That is, comparing the user interface 1020 of FIG. 10A and the user interface 1060 of FIG. 10B, the second card information 1022 is removed.

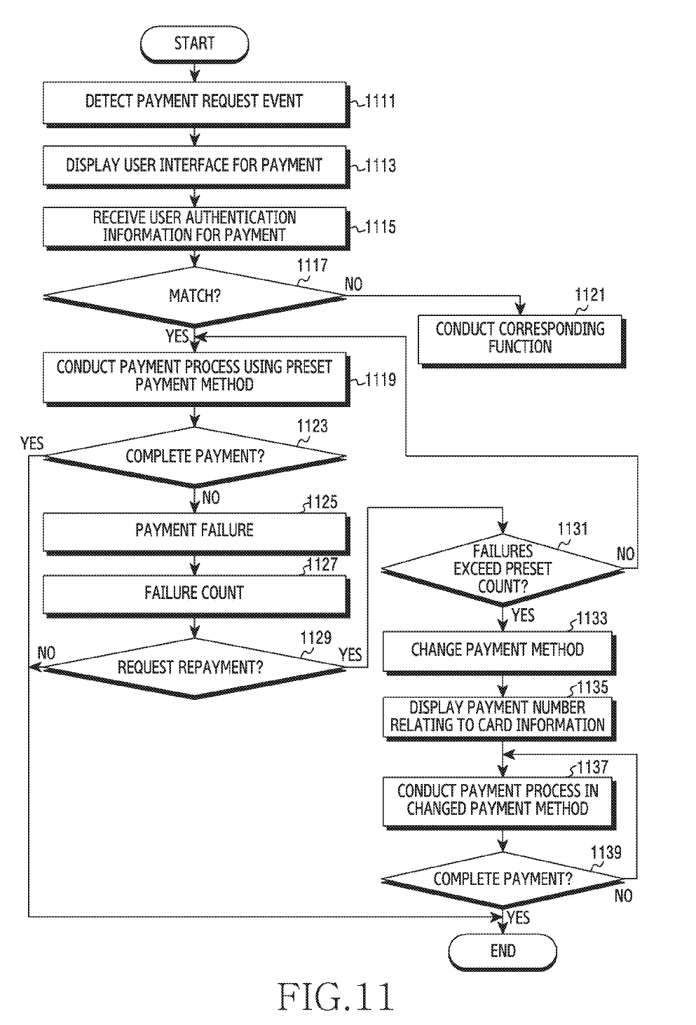

FIG. 11 a flowchart illustrating a payment method changing method of an electronic device according to various embodiments.

Referring to FIG. 11, in operation 1101, the electronic device 100 (e.g., the control unit 180) may detect a payment request event. For example, the payment request event may be a user input which selects any one card by executing a card-related application and then requests its payment. Alternatively, the payment request event may be a user gesture for the payment request in a lock screen or a home screen. If the payment request event is the user gesture for the payment request in the lock screen or the home screen, only card information registered in simple pay may be displayed.

In operation 1103, the control unit 180 may display a user interface for payment. For example, the user interface for the payment include a card image of a card selected from the user or a card image of a card used most recently for the payment. The user may change the card in order to pay with other card than cards displayed in the user interface for the payment.

In operation 1115, the control unit 180 may receive user authentication information for the payment. The user authentication information may be at least one of a fingerprint, a signature, and a password. The control unit 180 may also display a message for entering the user authentication information in the user interface for the payment. Based on the message, the user may contact his/her finger to a fingerprint scanning region of the electronic device 100 for the sake of fingerprint recognition.

In operation 1117, the control unit 180 may determine whether the received user authentication information is identical to authentication information stored in the memory 150. The control unit 180 may perform operation 1119 if the information matches, and perform operation 1121 if the information does not match. If the information does not match, in operation 1121, the control unit 180 may perform a corresponding function. For example, the control unit 180 may display a message for re-entering the user for authentication information, or terminate the payment process.

In operation 1119, the control unit 180 may perform the payment process in a preset payment manner. For example, if the preset payment manner is an MST method, the control unit 180 may drive an MST module. The MST module may generate a pulse according to data transmitted using an electromagnetic signal, and the pulse may generate a magnetic field signal. The MST module may transmit the magnetic field signal to a payment terminal (POS).

In operation 1123, the control unit 180 may determine whether the payment is completed. For example, if the payment is made using the MST method, after a payment processing time (e.g., 50 seconds) passes, the control unit 180 may determine whether a payment complete message is received from outside (e.g., a card company server or a VAN company). For example, the payment complete message may be a message corresponding to a payment authorization result “approval”. For example, the control unit 180 may terminate if the payment complete message is received, and perform operation 1125 if the payment complete message is not received. If receiving the payment complete message, the control unit 180 may stop driving the MST module and display a user interface including a payment complete notification message.

In operation 1125, the control unit 180 may determine payment failure. In operation 1127, the control unit 180 may count the number of payment failures. The control unit 180 may display a user interface for the payment, including a repayment request button. For example, the control unit 180 may terminate if the repayment request button is not selected, and perform operation 1131 if the repayment request button is selected. Alternatively, the control unit 180 may also terminate if the repayment request button is not selected within a preset time (e.g., 30 seconds). Alternatively, according to an embodiment, the control unit 180 may automatically attempt the repayment in the case of the payment failure.

In operation 1131, the control unit 180 may determine whether the number of the failures exceeds a preset count (e.g., two times). For example, the control unit 180 may return to operation 1119 if the number of the failures does not exceed the preset count, and perform operation 1133 if the number of the failures exceeds the preset count. When returning to operation 1119, the control unit 180 may conduct operation 1119 through operation 1131.

In operation 1133, the control unit 180 may change the payment method. For example, the control unit 180 may change a preset payment method to another payment method. For example, if the preset payment method is the MST method, it may be changed to a barcode method. Alternatively, if the preset payment method is the MST method, it may be changed a number displaying method. The number displaying method may allow the user or a payer to manually enter digits.

In operation 1135, the control unit 180 may display a payment number relating to card information. The payment number may be at least one of a card number, a PIN number, and a barcode number. For example, the control unit 180 may display the card number and the PIN number relating to the card information. Alternatively, the control unit 180 may display the barcode number relating to the card information. Alternatively, the control unit 180 may display the barcode number and a barcode image in relation to the card information. According to various embodiments, the control unit 180 may generate a barcode number using the card number. That is, the control unit 180 may convert the card number to a barcode number, and display the barcode image and the barcode number together. The barcode image may be a concept including both of a one-dimensional barcode and a two-dimensional barcode (e.g., QR code).

In operation 1137, the control unit 180 may perform a payment process using the changed payment method. If the changed payment method is the barcode method, the control unit 180 may display the barcode image and the barcode number on the screen to thus recognize the barcode image using a barcode reader. Alternatively, if the changed payment method is the number display method, the control unit 180 may display the payment number so that the user or the payer may manually enter the payment number.

In operation 1139, the control unit 180 may determine whether the payment is completed. For example, after the payment number is displayed, after a preset time (e.g., 60 seconds) is passed, the control unit 180 may identify whether a payment complete message is received from outside (e.g., a card company server or a VAN company). For example, the payment complete message may be a message corresponding to the payment authentication result “approval”. For example, the control unit 180 may terminate if the payment complete message is received, and return to operation 1137 if the payment complete message is not received. If the payment complete message is received, the control unit 180 may stop displaying the payment number and display a user interface including a payment complete notification message.

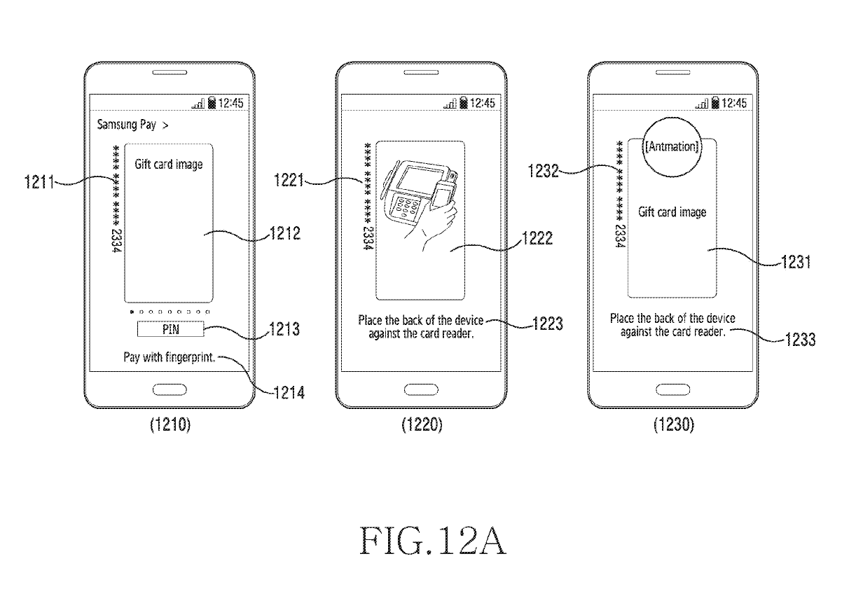

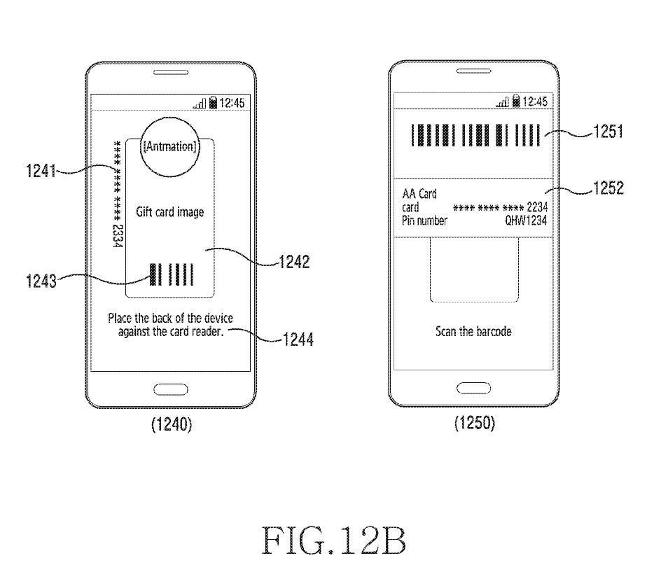

FIGS. 12A and 12B are diagrams illustrating an example of a user interface relating to payment method change according to various embodiments.

FIG. 12A depicts a user interface for processing payment using a preset method.

Referring to FIG. 12A, a reference numeral ‘1210’ is related to the user interface for the payment. The user interface 1210 for the payment may include an encrypted card number 1211, a card image 1212, an encrypted PIN number 1213, and a fingerprint request message 1214. For example, the control unit 180 may display the user interface 1210 for the payment in the payment processing using an MST method. In addition, the control unit 180 may display the user interface 1210 for the payment until exceeding an initial or preset failure count. That is, the user interface 1210 for the payment may be displayed by encrypting the card number and the PIN number for the sake of security.

A reference numeral ‘1220’ is related to a user interface for guiding the user to the payment method in the payment processing. The payment guide user interface 1220 may include an encrypted card number 1221, a payment guide image 1222, and a payment guide message 1223. Based on the payment guide image 1222 and the payment guide message 1223, the user may place the electronic device 100 close to a payment terminal. A reference numeral ‘1230’ depicts another example of the payment guide user interface. For example, the payment guide user interface 1230 may include an encrypted card number 1232, a card image 1231, and a payment guide message 1233.

FIG. 12B depicts another example of the user interface which processes the payment using a preset method.

Referring to FIG. 12B, a reference numeral ‘1240’ is related to a user interface for payment. The user interface 1240 for the payment may include an encrypted card number 1241, a card image 1242, a barcode image 1243, and a payment guide message 1244. For example, the control unit 180 may display the user interface 1240 for the payment in the payment processing using a barcode method. In addition, the control unit 180 may display the user interface 1240 for the payment until exceeding an initial or preset failure count. In other words, the user interface 1240 for the payment may encrypt and display a card number for the sake of security, or may not display the barcode number. A reference numeral ‘1250’ is related to another different example of the user interface for the payment. The user interface 1250 for the payment may include a barcode image 1251 and encrypted card information 1252. The card information 1252 may include a card name, an encrypted card number encryption, and an encrypted PIN number.

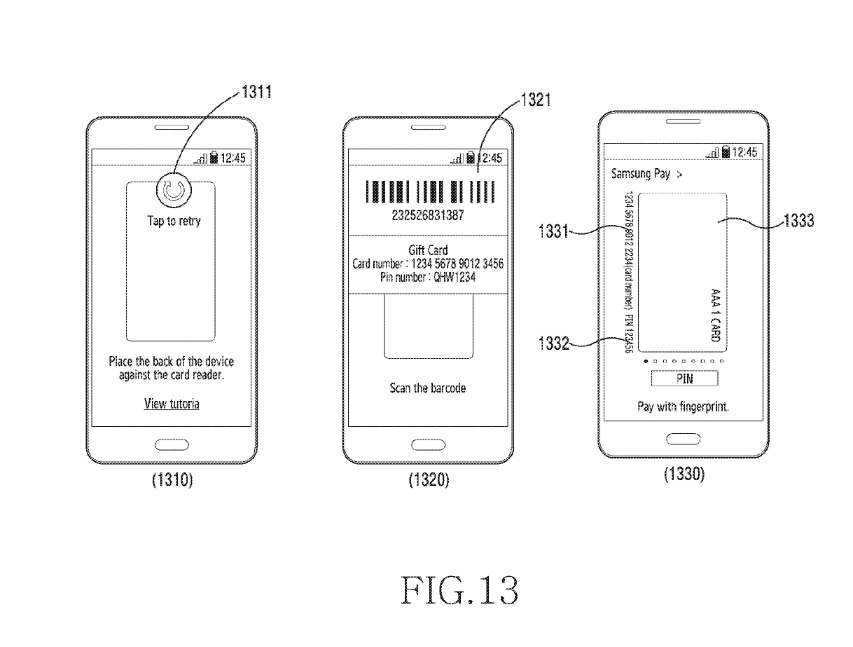

FIG. 13 is a diagram illustrating an example of a user interface in payment according to various embodiments.

Referring to FIG. 13, a reference numeral ‘1310’ is related to a user interface displayed for payment failure. The payment failure notification user interface 1310 may include a repayment request button 1311. If the repayment request button 1311 is selected, the control unit 180 may determine whether the number of failures exceeds a preset count. The control unit 180 may perform a payment process in a preset method if the number of failures does not exceed the preset count.

A reference numeral ‘1320’ is related to a user interface displayed in payment processed using a changed payment method. If the number of failures exceeds the preset count, the control unit 180 may change the payment method, and display the user interface 1320 of the changed payment method. The user interface 1320 of the changed payment method may include a barcode image, and display a barcode number 1321 without encrypting it. Alternatively, the user interface 1320 of the changed payment method may display a card number and a PIN number 1332 without encrypting them. Thus, the user or a payer may manually enter the barcode number 1321 or the card number and PIN number 1332. A reference numeral ‘1330’ is related to another example of a user interface displayed in payment processed using the changed payment method. The user interface 1330 of the changed payment method may include a card number 1331, a PIN number 1332, and a card image 1333. That is, the user interface 1330 of the changed payment method may display the card number 1331 and the PIN number 1332 without encrypting them.

An operating method of an electronic device according to various embodiments may include displaying a user interface relating to at least one of card registration, card purchase, card removal, or payment method change, detecting a user event, and conducting a process relating to the card registration, the card purchase, the card removal, or the payment method change based on the detected user input.

Conducting the card registration process may include displaying a user interface for additional card registration, and registering card information by conducting an information input process or a card purchase process based on a user input which is detected in the user interface for the additional card registration.

The information input process may provide a user interface for receiving at least one of a card brand, a card number, or a PIN number from a user, and provide a user interface including card information generated using the entered information and additional information received from a server.

Registering the card information by conducting the information input process may include transmitting the entered information to the server, receiving additional information corresponding to the entered information from the server, generating the card information based on the entered information and the additional information, and registering the generated card information.

The card purchase process may provide a user interface for entering card configuration information from a user, and provide an information input interface for presenting a card or an information input interface for purchasing a card.

Registering the card information by conducting the information purchase process may include, if payment is completed by conducting a payment process according to a card purchase, registering card information of a purchased card in a card-related application, or transmitting the card information of the purchased card to an electronic device of other party to send a gift.

Conducting the card removal process may include displaying a user interface comprising a presented card, identifying a type of a card selected from a user, and displaying a different user interface according to an identified type.

The operating method may further include, if the identified type is a first type, displaying a user interface regarding a first-type card, if return is selected in the user interface regarding the first-type card, transmitting card information of a returned card to a server, and removing the returned card information from a user interface including the presented card.

The operating method may further include, if the identified type is a second type, displaying a user interface regarding a second-type card, and if removal is selected in the user interface regarding the second-type card, not registering card information of a removed card in a card-related application.

Conducting the process of the payment method change may include, if a payment request event is detected, displaying a user interface for payment, processing payment using a preset payment method, and processing payment by changing a payment method if the payment fails.

Processing payment by changing the payment method may include, if the number of payment failures exceeds a preset count, displaying a payment number relating to card information.

The embodiments of the present invention disclosed in the specification and drawings merely present specific examples to easily explain details of the present invention and to ease the understanding, and do not limit the range of the present invention. Therefore, the scope of the present invention should be construed as encompassing all modifications or various embodiments derived based on the technical idea of the present invention as well the disclosed embodiments.

1. An electronic device comprising:
a display for displaying a user interface;
and
a processor operatively coupled with the display, wherein the processor configured to control the display to display a user interface relating to at least one of card registration, card purchase, card removal, or payment method change.

2. The electronic device of claim 1, wherein the processor is configured to, if detecting a card add event, control the display to display a user interface for additional card registration, and to register card information by conducting an information input process or a card purchase process based on a user input.

3. The electronic device of claim 2, wherein the information input process provides a user interface for entering at least one of a card brand, a card number, or a PIN number from a user, and provides a user interface comprising card information generated using the entered information and additional information received from a server.

4. The electronic device of claim 3, wherein the processor is configured to transmit the entered information to the server, to receive additional information corresponding to the entered information from the server, to generate the card information based on the entered information and the additional information, and to register the generated card information.

5. The electronic device of claim 2, wherein the card purchase process provides a user interface for entering card configuration information from a user, and provides an information input interface for presenting a card or an information input interface for purchasing a card.

6. The electronic device of claim 5, wherein, if payment is completed by conducting a payment process according to a card purchase, the processor is configured to register card information of a purchased card in a card-related application, or to transmit the card information of the purchased card to an electronic device of other party to send a gift.

7. The electronic device of claim 1, wherein the processor is configured to control the display to display a user interface comprising a presented card, to identify a type of a card selected from a user, and to display a different user interface according to an identified type.

8. The electronic device of claim 7, wherein, if the identified type is a first type, the processor is configured to control the display to display a user interface regarding a first-type card, if return is selected in the user interface regarding the first-type card, to transmit card information of a returned card to a server, and to remove the returned card information from a user interface comprising the presented card.

9. The electronic device of claim 7, wherein, if the identified type is a second type, the processor is configured to control the display to display a user interface regarding a second-type card, and if removal is selected in the user interface regarding the second-type card, not to register card information of a removed card in a card-related application.

10. The electronic device of claim 1, wherein, if a payment request event is detected, the processor is configured to control the display to display a user interface for payment, to process payment using a preset payment method, and to process payment by changing a payment method if the payment fails.

11. The electronic device of claim 10, wherein, if a number of payment failures exceeds a preset count, the processor is configured to control the display to display a payment number relating to card information.

12. An operating method of an electronic device, comprising:
displaying a user interface relating to at least one of card registration, card purchase, card removal, or payment method change;
detecting a user event; and
conducting a process relating to the card registration, the card purchase, the card removal, or the payment method change based on the detected user input.

13. The operating method of claim 12, wherein conducting the card registration process comprises:
displaying a user interface for additional card registration; and
registering card information by conducting an information input process or a card purchase process based on a user input which is detected in the user interface for the additional card registration.

14. The operating method of claim 13, wherein the information input process provides a user interface for receiving at least one of a card brand, a card number, or a PIN number from a user, and provides a user interface comprising card information generated using the entered information and additional information received from a server.

15. The operating method of claim 14, wherein registering the card information by conducting the information input process comprises:
transmitting the entered information to the server;
receiving additional information corresponding to the entered information from the server;
generating the card information based on the entered information and the additional information; and
registering the generated card information.

16. The operating method of claim 13, wherein the card purchase process comprising:
providing a user interface for entering card configuration information from a user; and
providing an information input interface for presenting a card or an information input interface for purchasing a card.

17. The operating method of claim 16, wherein registering card information comprises:
if payment is completed by conducting a payment process according to a card purchase, registering card information of a purchased card in a card-related application, or transmitting the card information of the purchased card to an electronic device of other party to send a gift.

18. The operating method of claim 12, wherein conducting a process relating to the card removal comprises:
displaying a user interface comprising a presented card;
identifying a type of a card selected from a user; and
displaying a different user interface according to an identified type.

19. The operating method of claim 18, further comprising:
if the identified type is a first type, displaying a user interface regarding a first-type card;
if return is selected in the user interface regarding the first-type card, transmitting card information of a returned card to a server; and
removing the returned card information from a user interface comprising the presented card.

20. The operating method of claim 12, wherein conducting a process relating to the payment method change comprises:
if a payment request event is detected, displaying a user interface for payment;
processing payment using a preset payment method; and
processing payment by changing a payment method if the payment fails.
